(19) United States
(12) Patent Application Publication
(10) Pub. No.: US 2006/0071484 A1
(43) Pub. Date: Apr. 6, 2006

(54) Door lock assembly

(75) Inventor: Waterson Chen, Taichung City (TW)

Correspondence Address: MERCHANT & GOULD PC, P.O. BOX 2903, MINNEAPOLIS, MN, 55402-0903, US

(73) Assignee: WATERSON CORP., Taichung City (TW)

(21) Appl. No.: 11/016,266

(22) Filed: Dec. 17, 2004

(30) Foreign Application Priority Data
Sep. 27, 2004 (TW) 93129233

(51) Int. Cl. E05B 3/00

(52) U.S. Cl. 292/336.3

(57) ABSTRACT

A door lock assembly includes: a first engaging member secured in a socket in the door frame; and a latch mechanism including a hollow mounting body mounted on the door panel, and a latch unit including a latch bolt that is retractable into the hollow mounting body, and that is operable to move relative to the hollow mounting body from a first retracted position to an extended position, in which the latch bolt extends into the socket. The latch unit further includes a second engaging member that is mounted movably on the latch bolt and that is actuated to move relative to the latch bolt from a disengaging position to an engaging position, in which the second engaging member engages releasably the first engaging member.

### BACKGROUND OF THE INVENTION

1. Field of the Invention

This invention relates to a door lock assembly, more particularly to a door lock assembly that has an improved anti-picking effect and that can be used for door panels that differ in panel thickness.

2. Description of the Related Art

Conventional door lock assemblies normally include a latch mechanism mounted in a door panel, and a socket mounted in a door frame. The latch mechanism includes a latch bolt that is extendable into the socket so as to lock the door panel to the door frame when the door panel is moved to a closed position relative to the door frame. In order to have an automatic locking ability, an engaging end of the latch bolt is tapered and curved so that the latch bolt is able to be retracted into the door panel when the engaging end of the latch bolt strikes a strike plate of the socket. However, the design as such is susceptible to lock-picking. Using a tool extended into a gap between the latch bolt and the socket, a thief can easily move the engaging end of the latch bolt and unlock the door.

Another conventional type of the latch bolt has a rectangular engaging end that is capable of eliminating the aforesaid lock-picking drawback. However, the latch bolt as such cannot automatically retract into the door panel when the engaging end of the latch bolt strikes the strike plate of the socket.

In addition, the conventional door lock assemblies further include a front actuating mechanism with a lock, and a rear actuating mechanism with a rear handle. Both the lock and the rear handle are coupled to a lock-driving rod that extends through the latch mechanism for driving the latch bolt to move between latched and unlatched positions. Therefor, a person who is indoors can open the door by turning the rear handle, while a person who is outdoors is required to use a key to open the door.

The conventional door lock assemblies have the following drawbacks:

1. Since the front and rear actuating mechanisms are separate parts, both are required to be kept coaxially aligned so as to be coupled to the lock-driving rod during mounting to the door panel. However, since the two actuating mechanisms are to be mounted respectively on two sides of the door panel with the latch mechanism interposed therebetween, the alignment between the two actuating mechanisms becomes relatively difficult.

2. Since the front and rear actuating mechanisms are mounted to the door panel through screw means, in case that the front actuating mechanism is picked and is undesirably removed, the lock-driving rod will be exposed and can be turned to unlock the latch bolt.

3. The aforesaid drawback can be overcome by making the lock-driving rod into two parts, each of which is coupled to a respective one of the front and rear actuating mechanisms. However, since the length of each part of the lock-driving rod supplied from the factory is fixed, the total length of the lock-driving rod, that is fitted to a door panel with a predetermined thickness, will not be suited for a door panel having a different thickness.

### SUMMARY OF THE INVENTION

Therefore, the object of the present invention is to provide a door lock assembly that is capable of overcoming at least one of the aforesaid drawbacks of the prior art.

According to the present invention, there is provided a door lock assembly for locking a door panel to a door frame. The door lock assembly comprises: a first engaging member adapted to be secured in a socket in the door frame; and a latch mechanism including a hollow mounting body adapted to be mounted on the door panel, and a latch unit including a latch bolt that is retractable telescopically into the hollow mounting body, and that is operable to move relative to the hollow mounting body in a longitudinal direction from a first retracted position to an extended position, in which the latch bolt is capable of extending into the socket. The latch unit further includes a second engaging member that is mounted movably on the latch bolt and that is actuated to move relative to the latch bolt from a disengaging position to an engaging position, in which the second engaging member engages releasably the first engaging member, during movement of the latch bolt from the first retracted position to the extended position.

### BRIEF DESCRIPTION OF THE DRAWINGS

In drawings which illustrate embodiments of the invention,

FIG. 1 is a fragmentary sectional view of the first preferred embodiment of a door lock assembly according to the present invention;

FIG. 2 is an exploded perspective view of the first preferred embodiment;

FIG. 3 is a schematic sectional side view of a latch mechanism of the first preferred embodiment, illustrating a state where a latch bolt is disposed at an extended position;

FIG. 4 is a schematic sectional view to illustrate how a pair of engaging balls of a second engaging member of the latch bolt of the first preferred embodiment are in sliding contact with two opposing flat surfaces of a hollow mounting body;

FIG. 5 is a fragmentary schematic sectional view to illustrate how a front latch-driving member and a rear latch-driving member are coupled respectively to a pair of swingable members of a key-operated driving unit of the first preferred embodiment;

FIG. 6 is a fragmentary sectional top view corresponding to FIG. 3;

FIG. 7 is an exploded perspective view to illustrate how the latch mechanism is sandwiched by front and rear mounting seats of the first preferred embodiment;

FIG. 8 is an exploded perspective view of the first preferred embodiment according to this invention, with front and rear pads sandwiching the front and rear mounting seats;

FIG. 9 is another fragmentary sectional view of the first preferred embodiment;

FIG. 10 is an exploded perspective view of a front actuating mechanism of the first preferred embodiment;

FIG. 11 is a schematic sectional view of the front actuating mechanism of the first preferred embodiment;

FIG. 12 is a perspective cutaway view of an inner sleeve of a lock-mounting seat of the front actuating mechanism of the first preferred embodiment;

FIG. 13 is an exploded perspective view of a lock with a cam and a cam follower of the front actuating mechanism of the first preferred embodiment;

FIG. 14 is an exploded perspective view of a rear actuating mechanism of the first preferred embodiment;

FIG. 15 is a schematic sectional view of the rear actuating mechanism of the first preferred embodiment;

FIG. 16 is a fragmentary sectional view to illustrate how the rotational extent of a handle seat is limited by a rear rose of the rear actuating mechanism of the first preferred embodiment;

FIG. 17 is a sectional view to illustrate how a spring-biased positioning member engages a pushing rod of the rear actuating mechanism of the first preferred embodiment;

FIG. 18 is a schematic sectional side view to illustrate how a positioning pin disengages from a front recess in a hollow mounting body of the latch mechanism of the first preferred embodiment upon rotation of the key-operated driving unit in a clockwise direction;

FIG. 19 is a schematic sectional top view corresponding to FIG. 18;

FIG. 20 is a schematic sectional side view to illustrate a state where the latch bolt of the latch mechanism of the first preferred embodiment is disposed at a first retracted position;

FIG. 21 is a schematic sectional top view corresponding to FIG. 20;

FIG. 22 is a schematic sectional side view to illustrate a state where the latch bolt of the latch mechanism of the first preferred embodiment is disposed at a second retracted position;

FIG. 23 is a schematic sectional top view corresponding to FIG. 22;

FIG. 24 is a sectional view to illustrate a state where the cam follower is axially moved to engage the front latch-driving member of the front actuating mechanism of the first preferred embodiment;

FIG. 25 is a sectional view to illustrate a state where the rear latch-driving member is axially moved to engage a second wall of the hollow mounting body by a pushing action acting on the pushing rod of the rear actuating mechanism of the first preferred embodiment;

FIG. 26 is a schematic view to illustrate how an engaging protrusion of the pushing rod engages a rod-engaging groove in the rear mounting seat of the first preferred embodiment;

FIG. 27 is a schematic sectional view to illustrate how the positioning member is moved upwardly upon rotation of the handle seat of the rear actuating mechanism of the first preferred embodiment;

FIG. 28 is a schematic sectional view to illustrate how the lock is removed from the lock-mounting seat by inserting a tool through the front rose and the lock-mounting seat and by pushing a spring-biased engaging stud into the lock;

FIG. 29 is an exploded perspective view of a lock with an engaging stud modified from the one shown in FIG. 13;

FIG. 30 is an exploded perspective view of a front actuating mechanism and a latch mechanism of the second preferred embodiment according to this invention, with the front actuating mechanism modified from the one shown in FIG. 10;

FIG. 31 is a schematic sectional view of the second preferred embodiment;

FIG. 32 is an exploded perspective view of the third preferred embodiment according to this invention, with the rear actuating mechanism modified from the one shown in FIG. 14;

FIG. 33 is a perspective view of the fourth preferred embodiment according to this invention, with the rear actuating mechanism modified from the one shown in FIG. 14;

FIG. 34 is a schematic sectional view of the fourth preferred embodiment;

FIGS. 35a and 35b are schematic sectional views to illustrate a state where a locking protrusion of the rear actuating mechanism of the fourth preferred embodiment is offset from a retaining indentation when the pushing rod is disposed at a releasing position;

FIGS. 36a and 36b are schematic sectional views to illustrate a state where the locking protrusion of the rear actuating mechanism of the fourth preferred embodiment is aligned with and engages the retaining indentation when the pushing rod is disposed at a holding position;

FIG. 37 is a perspective view of the fifth preferred embodiment of the door lock assembly according to this invention;

FIG. 38 is a perspective cutaway view of the fifth preferred embodiment;

FIG. 39 is an exploded perspective view of a front actuating mechanism of the fifth preferred embodiment;

FIG. 40 is an exploded perspective view of a rear actuating mechanism of the fifth preferred embodiment;

FIG. 41 is a schematic sectional view of the fifth preferred embodiment mounted on a thin door panel;

FIG. 42 is a schematic sectional view of the fifth preferred embodiment mounted on a thick door panel;

FIG. 43 is an exploded perspective view of the sixth preferred embodiment according to this invention, with the rear actuating mechanism modified from the one shown in FIG. 14;

FIG. 44 is a schematic sectional view of the sixth preferred embodiment mounted on a thin door;

FIG. 45 is a schematic sectional view of the sixth preferred embodiment mounted on a thick door;

FIG. 46 is an exploded perspective view of the sixth preferred embodiment, illustrating the front actuating mechanism modified from the one shown in FIG. 10;

FIGS. 47a and 47b are schematic sectional views of the seventh preferred embodiment according to this invention, with a control unit for controlling engagement and disengagement between the cam follower and the front latch-driving member;

FIGS. 48a and 48b are schematic sectional views of the seventh preferred embodiment to illustrate how the cam is actuated using a key (not shown) to permit engagement between the cam follower and the front latch-driving member; and

FIGS. 49a and 49b are schematic sectional views of the seventh preferred embodiment to illustrate how the control unit is operated through an electromagnetic valve to permit engagement between the cam follower and the front latch-driving member.

### DETAILED DESCRIPTION OF THE PREFERRED EMBODIMENTS

For the sake of brevity, same reference numerals are used to denote similar elements throughout the specification.

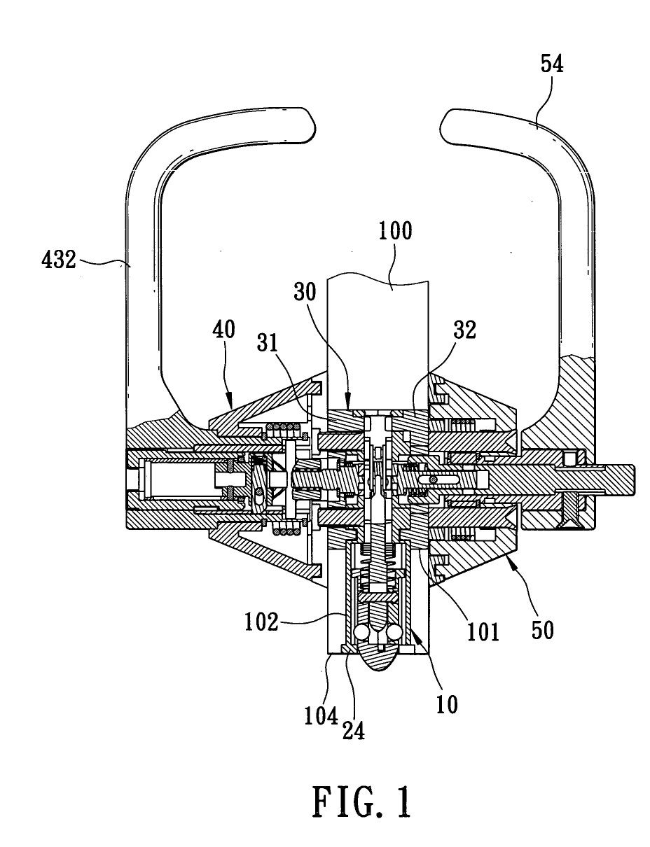

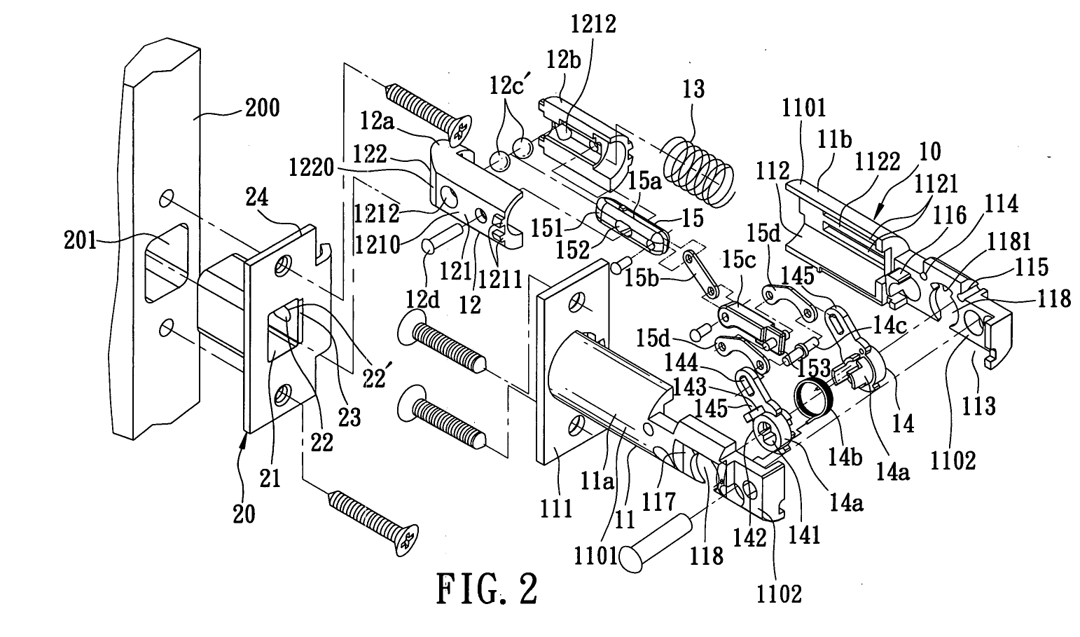

FIGS. 1 to 3 illustrate the first preferred embodiment of a door lock assembly for locking a door panel 100 to a door frame 200 according to the present invention. The door panel 100 is formed with a lock-mounting hole 101, and has a side wall formed with a side hole 102 that is in spatial communication with the lock-mounting hole 101. The door frame 200 is formed with a socket-mounting hole 201 that is aligned with the side hole 102 in the door panel 100. The door lock assembly includes a latch mechanism 10 that is to be mounted in the lock-mounting hole 101 in the door panel 100, a socket 20 that is to be mounted in the socket-mounting hole 201 in the door frame 200 and that defines a socket hole 21 therein, a mounting mechanism 30 that is to be mounted in the lock-mounting hole 101 in the door panel 100, a front actuating mechanism 40 that is to be mounted on a front side of the door panel 100 and that is coupled to the latch mechanism 10, and a rear actuating mechanism 50 that is to be mounted on a rear side of the door panel 100 and that is coupled to the latch mechanism 10. The socket 20 is formed with a first engaging member 22′ therein.

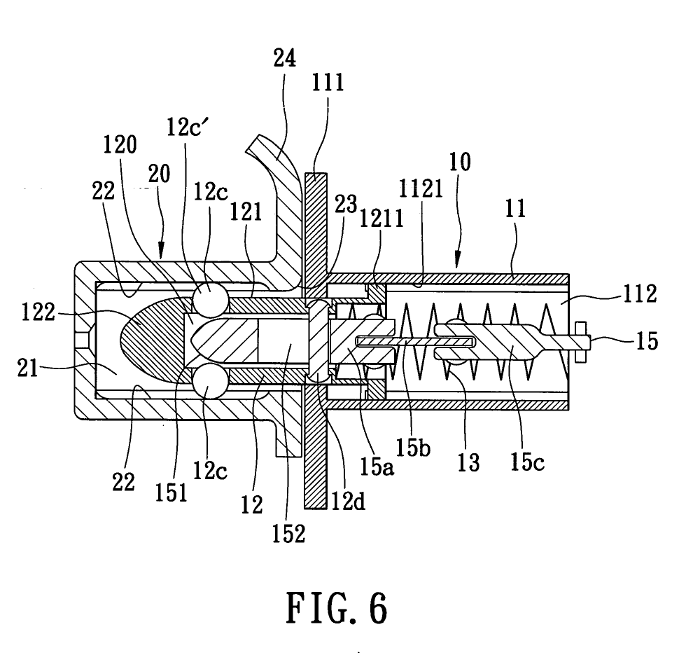

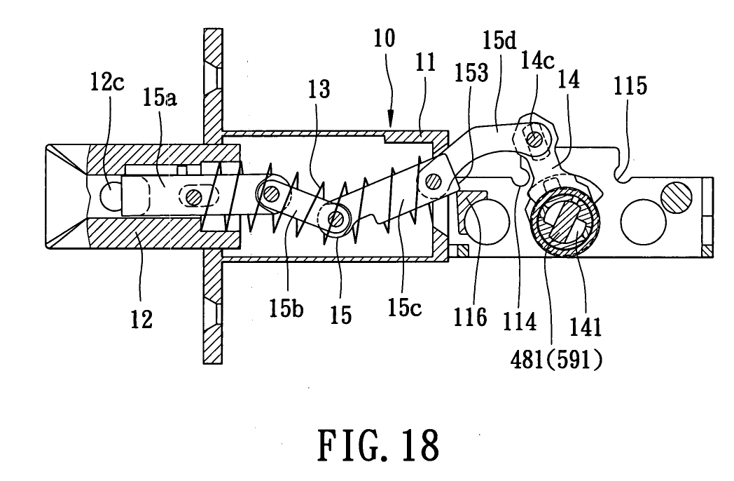

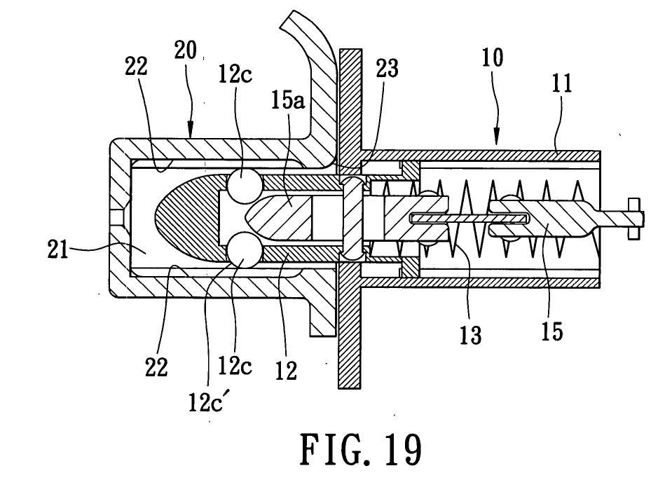

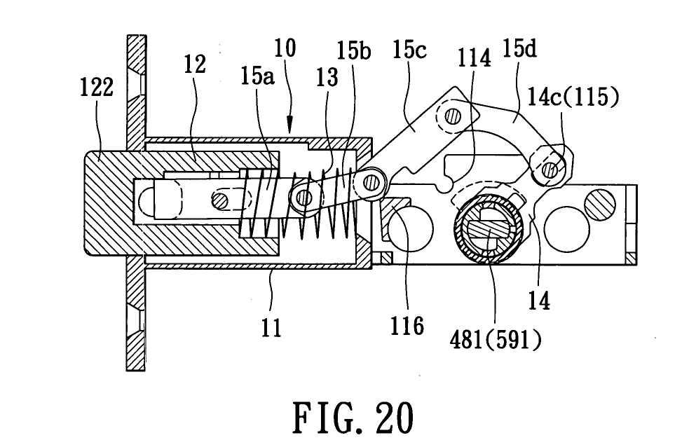

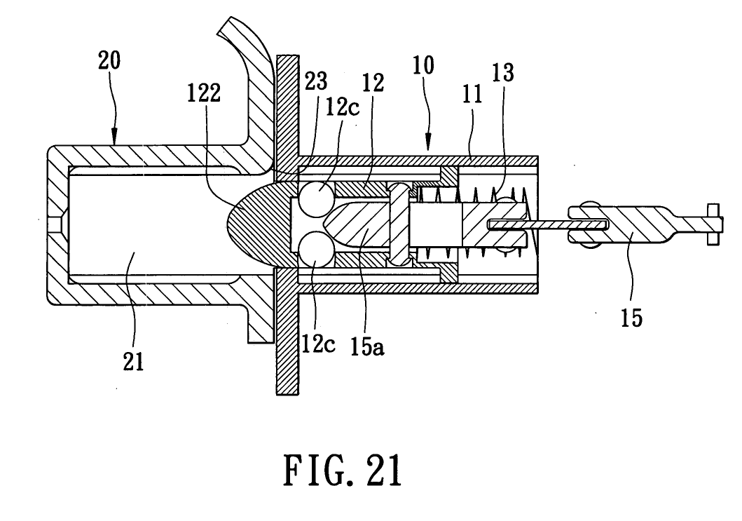

The latch mechanism 10 includes a hollow mounting body 11 that is to be mounted in the lock-mounting hole 101 in the door panel 100, and a latch unit 12′ that has a latch bolt 12 which is retractable telescopically into the hollow mounting body 11, and which is operable to move relative to the hollow mounting body 11 in a longitudinal direction from a first retracted position (see FIGS. 20 and 21) to an extended position (see FIGS. 6 and 18), in which the latch bolt 12 extends into the socket hole 21 in the socket 20. The latch unit 12′ further includes a second engaging member 12c′ that is mounted movably on the latch bolt 12 and that is actuated to move relative to the latch bolt 12 from a disengaging position (see FIG. 19) to an engaging position (see FIG. 6), in which the second engaging member 12c′ engages releasably the first engaging member 22′, during movement of the latch bolt 12 from the first retracted position to the extended position.

The hollow mounting body 11 is generally tubular in shape, and includes first and second halves 11a, 11b that are detachably mated together. A contact plate 111 is formed on one end of the first half 11a, is attached to the side wall of the door panel 100, and is adapted to be in contact with a strike plate 24 of the socket 20 when the door panel 100 is closed.

In this embodiment, the latch bolt 12 is hollow, includes two halves 12a, 12b that are mated together, defines an inner space 120 (see FIG. 6) between the halves 12a, 12b, and has a shank portion 121 and a tapered end portion 122 tapered from the shank portion 121 in a direction toward the socket 20. The shank portion 121 is received in the hollow mounting body 11, and is disposed outwardly of the socket 20, and the tapered end portion 122 extends into the socket 20 when the latch bolt 12 is disposed at the first retracted position (see FIG. 21). The shank portion 121 and the tapered end portion 122 extend into the socket 20 when the latch bolt 12 is disposed at the extended position (see FIG. 6). The shank portion 121 has two flat side walls 1210 that are parallel to each other. The tapered end portion 122 has two side walls 1220 that are curvedly tapered from the side walls 1210 of the shank portion 121. Each of the side walls 1210 of the shank portion 121 is formed with a ball-mounting hole 1212. The side walls 1210, 1220 of the shank portion 121 and the tapered end portion 122 cooperatively define the first and second halves 12a, 12b of the latch bolt 12.

The first engaging member 22′ preferably has a pair of opposing engaging grooves 22 that are formed in the socket 20. The second engaging member 12c′ preferably includes a pair of engaging balls 12c that are disposed in the inner space 120 in the latch bolt 12, that are respectively retained in the ball-mounting holes 1212 in the side walls 1210 of the shank portion 121, that protrude outwardly of and respectively through the ball-mounting holes 1212, and that are operable to move relative to the latch bolt 12 respectively toward and away from the engaging grooves 22 in the socket 20 such that the engaging balls 12c engage respectively the engaging grooves 22 in the socket 20 when the second engaging member 12c′ is disposed at the engaging position (see FIG. 6) and that the engaging balls 12c disengage respectively the engaging grooves 22 in the socket 20 when the second engaging member 12c′ is disposed at the disengaging position (see FIG. 19).

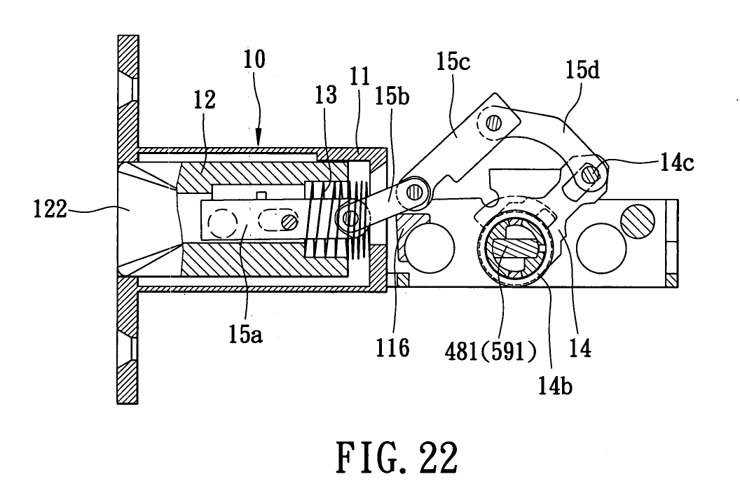

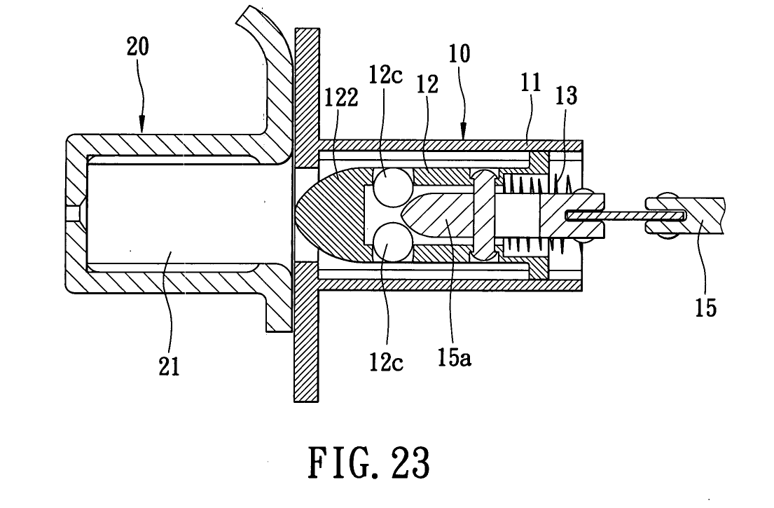

The latch mechanism 10 further includes a key-operated driving unit 14 mounted in the hollow mounting body 11 and operable to rotate about an axis transverse to the longitudinal direction, and a linking unit 15 mounted movably in the hollow mounting body 11 and disposed between and connected to the key-operated driving unit 14 and the latch bolt 12 so as to permit movement of the latch bolt 12 between the first retracted position (see FIG. 21) and the extended position (see FIG. 6) upon actuation of the key-operated driving unit 14 The latch bolt 12 is further operable so as to move from the first retracted position to a second retracted position (see FIGS. 22 and 23), in which the tapered end portion 122 is disposed outwardly of the socket 20 and is received in the hollow mounting body 11 when an external force is applied in the longitudinal direction to the tapered end portion 122 of the latch bolt 12.

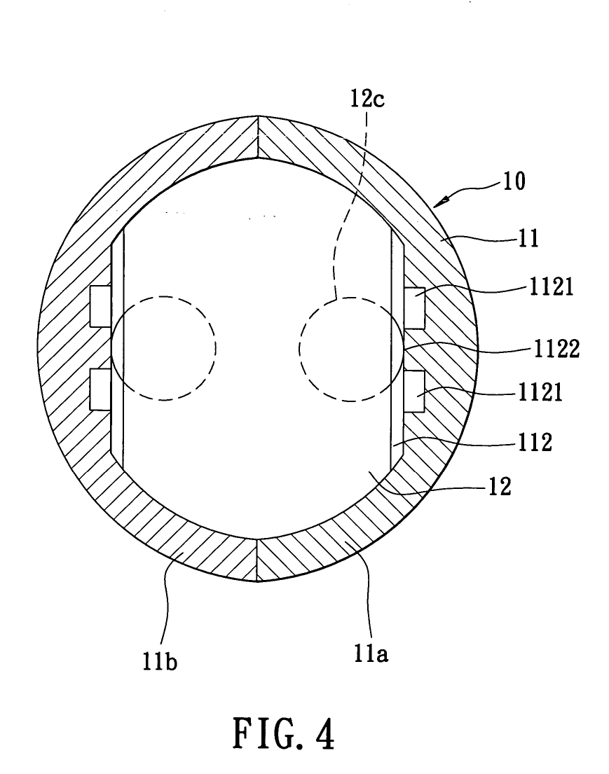

Each of the first and second halves 11a, 11b of the hollow mounting body 11 has a first wall 1101 and a second wall 1102 extending from the first wall 1101. The first wall 1101 is formed with a pair of parallel guiding grooves 1121 extending in the longitudinal direction, and a flat surface 1122 between the guiding grooves 1121. Each of the side walls 1210 of the shank portion 121 of the latch bolt 12 is formed with a pair of guiding studs 1211 that extend respectively into the guiding grooves 1121 in a respective one of the first walls 1101 of the first and second halves 11a, 11b of the hollow mounting body 11 (see FIG. 6). Each of the balls 12c is in sliding contact with the flat surface 1122 (see FIG. 4) of a respective one of the first walls 1101 of the first and second halves 11a, lib of the hollow mounting body 11 when the shank portion 121 of the latch bolt 12 is retracted into the hollow mounting body 11.

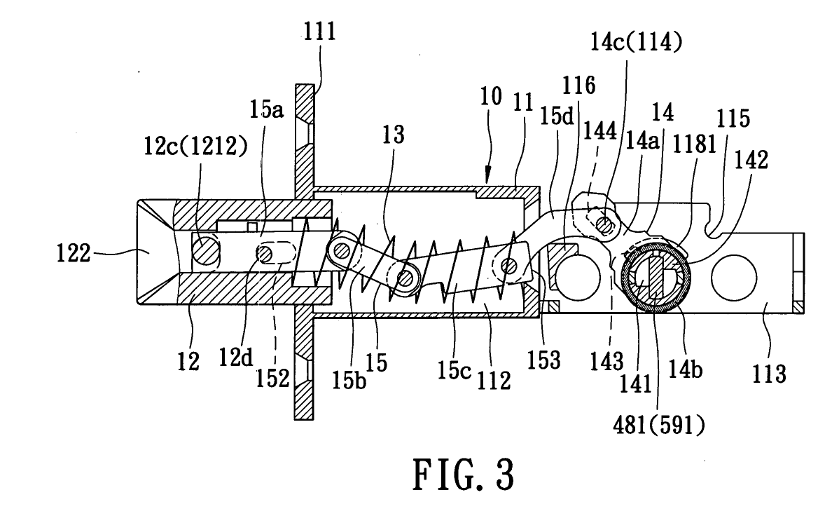

The hollow mounting body 11 defines a first space 112 between the first walls 1101 of the first and second halves 11a, 11b of the hollow mounting body 11, and a second space 113 between the second walls 1102 of the first and second halves 11a, 11b of the hollow mounting body 11. The first space 112 receives the latch bolt 12 therein when the latch bolt 12 is disposed at the second retracted position (see FIG. 23). The second space 113 accommodates the driving unit 14 and the linking unit 15. The hollow mounting body 11 is formed with a stopper 116 protruding into the second space 113, a pair of opposing first retaining recesses 114 that are opposite to each other in a transverse direction relative to the longitudinal direction, and a pair of opposing second retaining recesses 115. The first and second retaining recesses 114, 115 are disposed outwardly of and adjacent to the second space 113. The driving unit 14 includes a positioning pin 14c that has two opposite ends extending respectively into the first retaining recesses 114 (see FIG. 3) when the latch bolt 12 is disposed at the extended position, and respectively into the second retaining recesses 115 (see FIG. 20) when the latch bolt 12 is disposed at either the first or second retracted positions.

The linking unit 15 including a pushing lever 15a, a stopping linkage 15c, a middle linkage 15b disposed between and pivoted to the pushing lever 15a and the stopping linkage 15c, and a pair of cranks 15d having first ends that are pivoted to the stopping linkage 15c, and second ends that are pivoted to the positioning pin 14c. The pushing lever 15a has an end portion 151 that extends into the inner space 120 in the latch bolt 12 and that is disposed adjacent to the engaging balls 12c, and is operable to move relative to the latch bolt 12 in the longitudinal direction so as to push the engaging balls 12c to move in the transverse direction to engage respectively the engaging grooves 22 in the socket 20 upon movement of the latch bolt 12 to the extended position (see FIG. 6). The stopping linkage 15c has one end 153 that is in contact with and that is stopped by the stopper 116 when pushed to move linearly in the longitudinal direction toward the hollow mounting body 11 by an external force applied to the side walls 1220 of the tapered end portion 122 of the latch bolt 12 (see FIG. 3), thereby preventing movement of the latch bolt 12 from the extended position to the first retracted position. The cranks 15d are driven by the key-operated driving unit 14 through the positioning pin 14c to move along a circumferential path about the axis and to drive the stopping linkage 15c to move along a curved path, in which the stopping linkage 15c passes over the stopper 116 (see FIGS. 3 and 18) when the driving unit 14 is rotated about the axis in a first rotation direction, thereby permitting movement of the latch bolt 12 from the extended position to the first retracted position.

The pushing lever 15a is formed with an elongated opening 152. A connecting pin 12d extends through the elongated opening 152 in the pushing lever 15a and the side walls 1210 of the shank portion 121 of the latch bolt 12 so as to permit co-movement of the pushing lever 15a and the latch bolt 12. The elongated opening 152 in the pushing lever 15a permits movement of the pushing lever 15a relative to the latch bolt 12 and thus movement of the engaging balls 12c toward and away from the engaging grooves 22 in the socket 20.

Each of the second walls 1102 of the first and second halves 11a, 11b of the hollow mounting body 11 is formed with a retaining bore 118 that is in spatial communication with the second space 113, a sector-shaped recess 1181 that is in spatial communication with the retaining bore 118, and a non-circular recess 117 that surrounds the retaining bore 118.

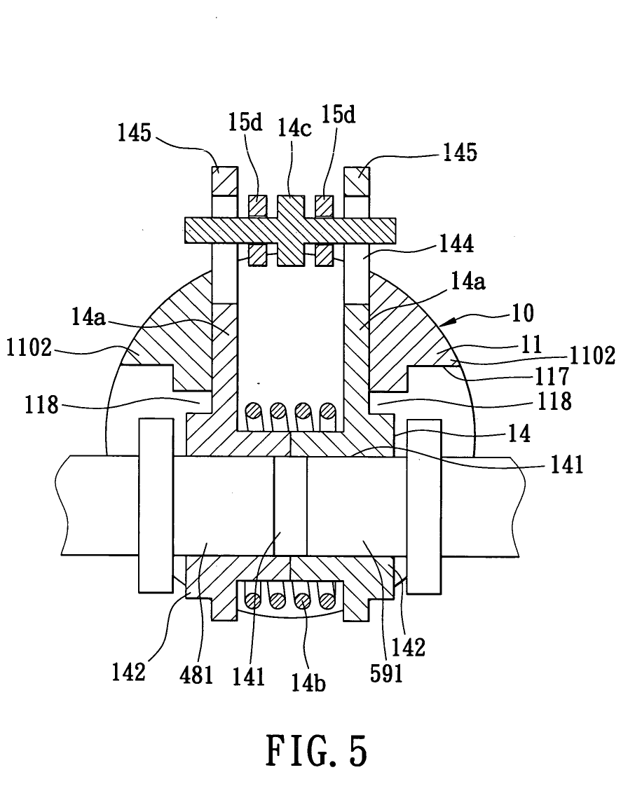

The key-operated driving unit 14 includes a pair of mated swingable members 14a that are rotatable between locking and unlocking positions (see FIGS. 3 and 20), and an urging member 14b disposed between and sleeved on the swingable members 14a for restoring the swingable members 14a to the locking position. The latch bolt 12 is disposed at the extended position when the swingable members 14a are disposed at the locking position. The latch bolt 12 is disposed at the first retracted position when the swingable members 14a are disposed at the unlocking position. Each of the swingable members 14a includes a ring-shaped body 142 that defines a non-circular engaging hole 141 and that is retained in the retaining bore 118 in a respective one of the second walls 1102 (see FIG. 5), a pin-supporting arm 145 that extends from the ring-shaped body 142 and that is formed with an elongated slot 144 for extension of the positioning pin 14c therethrough, and a stopping protrusion 143 that protrudes from the pin-supporting arm 145 into the sector-shaped recess 1181 in the respective second walls 1102 so as to limit the rotational range of the swingable members 14a to be within the first and unlocking positions. The elongated slot 144 permits movement of the positioning pin 14c along the length thereof and to disengage from the first retaining recesses 114 upon rotation of the swingable members 14a from the locking position toward the unlocking position.

The strike plate 24 has a curved guiding surface 23 for guiding movement of the latch bolt 12 from the first retracted position to the second retracted position before the latch bolt 12 can be automatically moved into the socket 20 to the extended position by an urging action of a restoring spring 13 during closing of the door panel 100. The restoring spring 13 has two opposite ends abutting respectively against the latch bolt 12 and the hollow mounting body 11, and is sleeved around the middle linkage 15b and a portion of the pushing lever 15a.

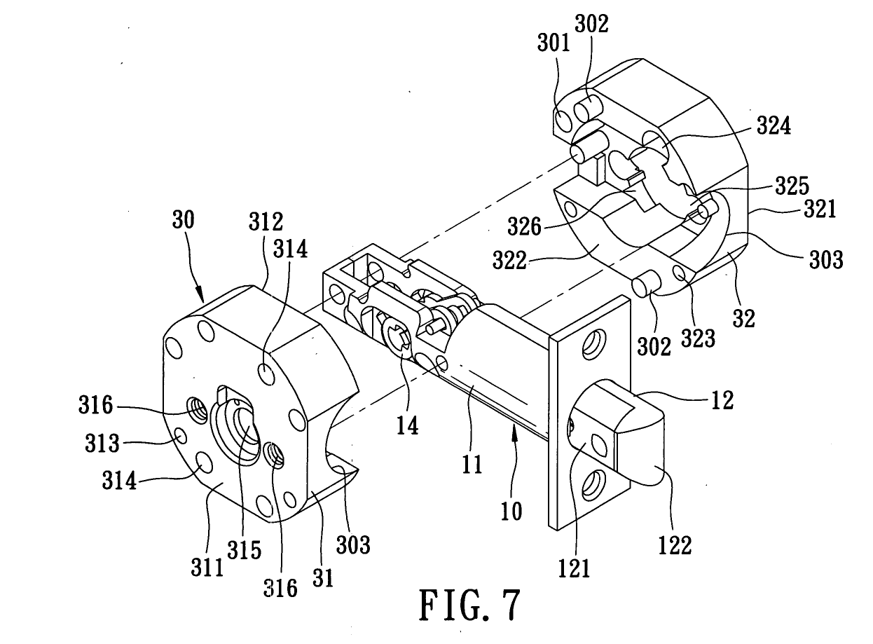

Referring to FIGS. 1 and 7, the mounting mechanism 30 includes opposite front and rear mounting seats 31, 32 which are adapted to be installed in the lock-mounting hole 101 in the door panel 100 and which sandwich the latch mechanism 10 therebetween. Each of the front and rear mounting seats 31, 32 is made from a metal material that is thermally treated so as to possess a hardness that is sufficient to prevent drilling and breaking. Each of the front and rear mounting seats 31, 32 has an outer surface 311 (321) and an inner surface 312 (322), and is formed with a plurality of first holes 313 (323) that open at the outer surface 311 (321), second holes 301 that open at the inner surface 312 (322), two through-holes 314 (324), a semi-circular recess 303, and positioning pins 302 projecting from the inner surface 312 (322). The front and rear mounting seats 31, 32 are coupled together through the second holes 301 and the positioning pins 302. The semi-circular recesses 303 of the front and rear mounting seats 31, 32 complement to each other so as to define cooperatively a circular hole that receives fittingly and respectively the first walls 1101 of the first and second halves 11a, 11b. The front mounting seat 31 is further formed with a central hole 315 and a pair of threaded holes 316 disposed at two diametrically opposite sides of the central hole 315. The rear mounting seat 32 is further formed with a central hole 325 and an engaging recess 326.

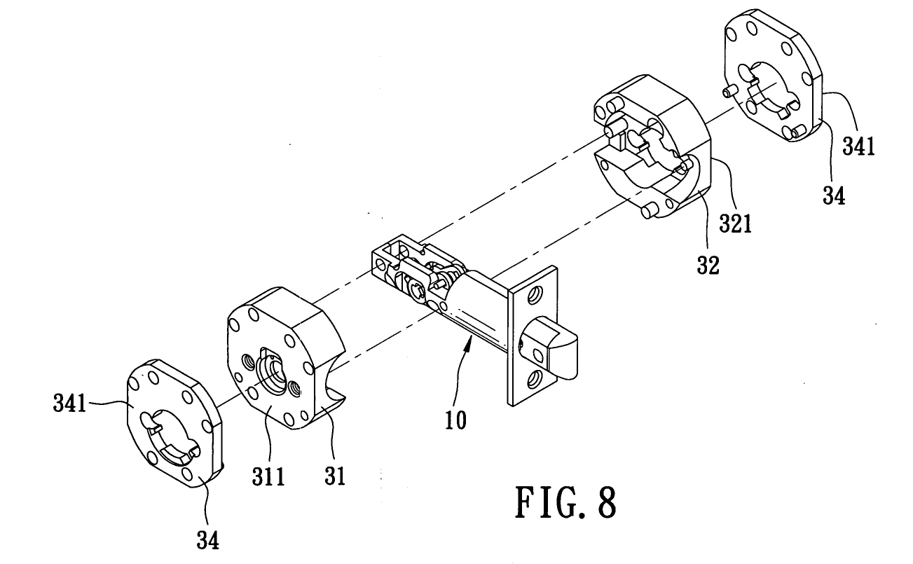

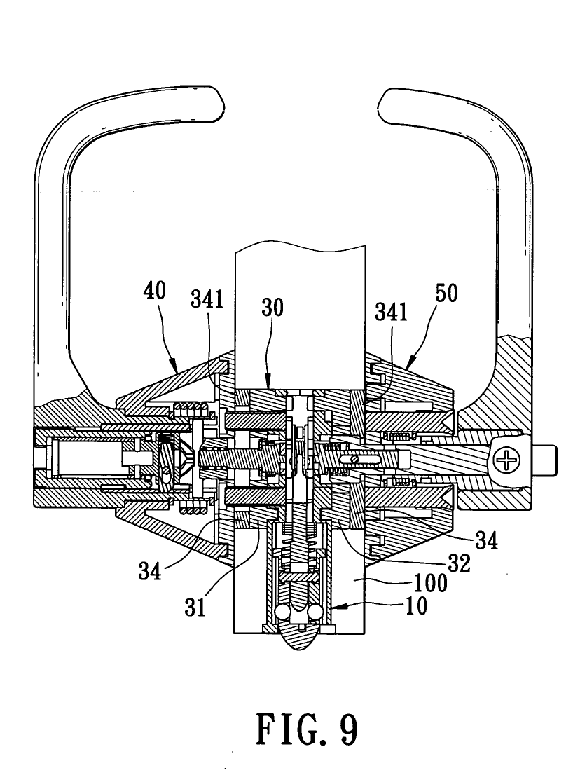

Referring to FIGS. 8 and 9, when the door lock assembly is to be used on a thick door panel, the mounting mechanism 30 can further include front and rear pads 34 that are respectively attached to the front and rear mounting seats 31, 32 so as to avoid a gap formed between each of the front and rear sides of the door panel 100 and the outer surface 311 (321) of the respective one of the front and rear mounting seats 31, 32. Each of the front and rear pads 34 has an outer surface 341 that is substantially flush with a respective one of front and rear sides of the door panel 100.

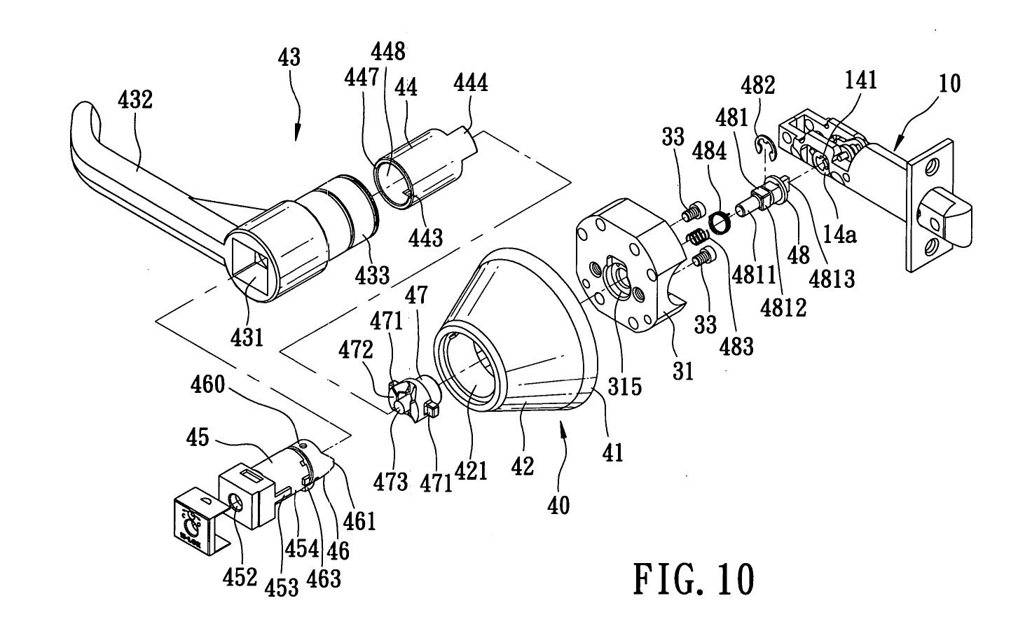

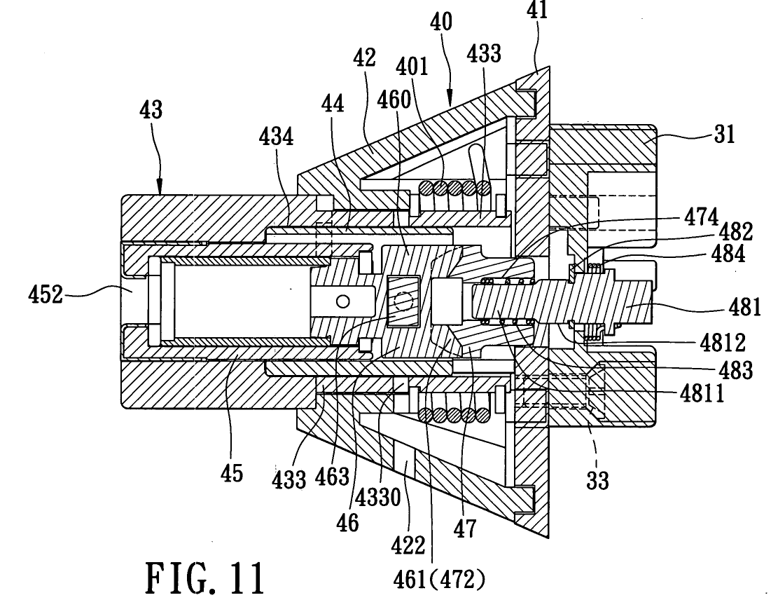

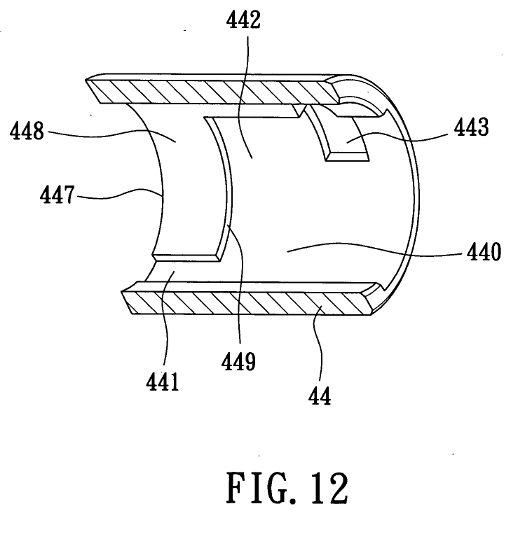

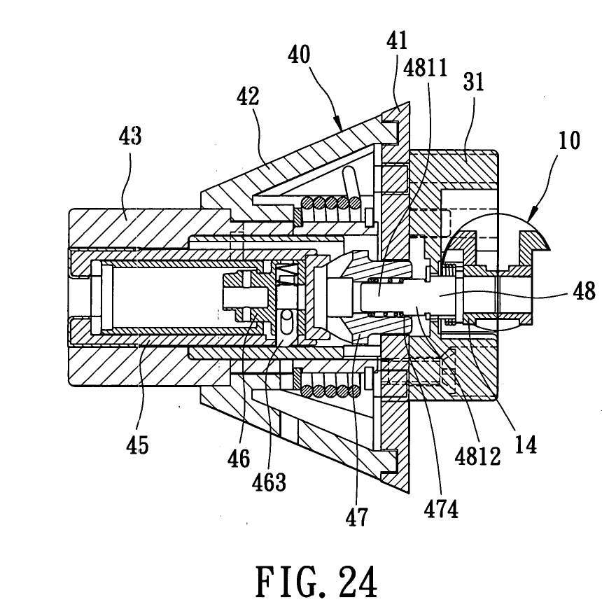

Referring to FIGS. 10 to 13, the front actuating mechanism 40 includes a front rose 42 adapted to be attached to the front side of the door panel 100 and formed with a ring-shaped base 41, a tubular lock-mounting seat 43 extending coaxially into the front rose 42 and rotatable relative to the front rose 42, a key-operated lock 45 mounted in the lock-mounting seat 43, a front latch-driving member 48 extending into the engaging hole 141 in the ring-shaped body 142 of a respective one of the swingable members 14a for driving rotation of the swingable members 141a, a cam 46 coupled to the key-operated lock 45 so as to rotate upon actuation of the key-operated lock 45, and a cam follower 47 coupled slidably to the lock-mounting seat 43 and further coupled to the cam 46 so as to be driven by the cam 46 to slide relative to the lock-mounting seat 43 in the transverse direction from a first axial position (see FIG. 11) to a second axial position (see FIG. 24), in which the cam follower 47 is coupled to the front latch-driving member 48, which results in coupling of the front latch-driving member 48 to the lock-mounting seat 43 so as to permit co-rotation of the lock-mounting seat 43 and the front latch-driving member 48.

The ring-shaped base 41 of the front rose 42 includes a plurality of positioning pins (not shown) for extension into the positioning holes 313 in the front mounting seat 31. The ring-shaped base 41 s secured to the front mounting seat 31 through screw means 33 in such a manner so as to attach to the front side of the door panel 100. The front rose 42 defines a front opening 421 for extension of the key-operated lock 45 therethrough.

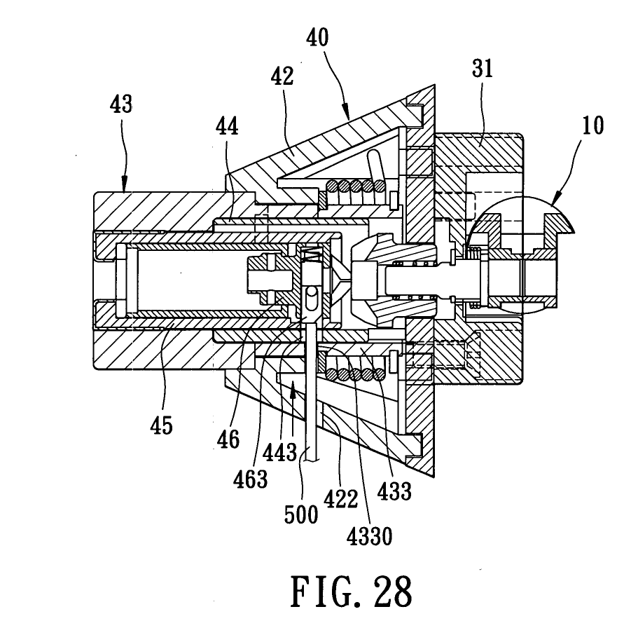

The lock-mounting seat 43 includes an inner sleeve 44 that surrounds the cam follower 47 and that is formed with an elongated rectangular opening 443 and a pair of opposing abutting legs 444 (see FIG. 10), and an outer sleeve 433 that surrounds the inner sleeve 44 and the key-operated lock 45 and that is formed with a first opening 4330 (see FIGS. 11 and 28) and a front handle 432. The abutting legs 444 abut against the ring-shaped base 41 for positioning the inner sleeve 44 within the outer sleeve 433. The outer sleeve 433 defines a rectangular sleeve channel 431 and a cylindrical sleeve channel 434 extending from the rectangular sleeve channel 431 for receiving the inner sleeve 44, and has an inner wall that is formed with a pair of sliding grooves (not shown). The cam follower 47 is formed with a pair of guiding studs 471 that engage respectively and slidably the sliding grooves in the outer sleeve 433.

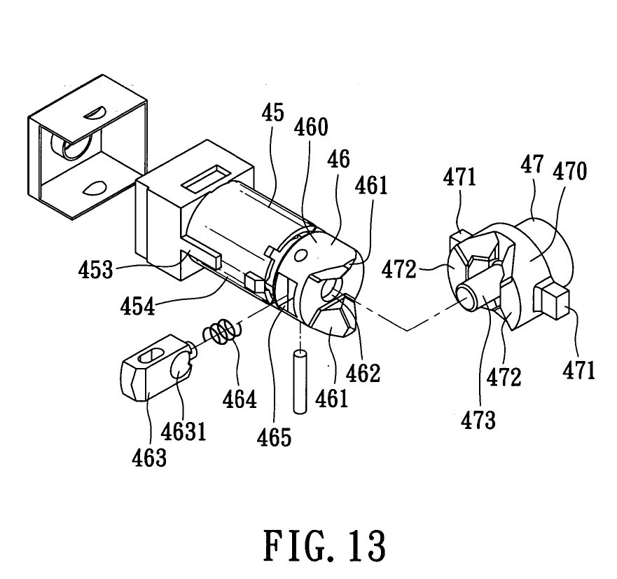

The inner sleeve 44 is made from a material that is thermally treated so as to have a relatively high hardness to prevent lock-picking. The inner sleeve 44 is rotatable relative to the outer sleeve 433, and has an inserting end 447 and an inner wall 448 that is formed with an L-shaped recess 440 (see FIG. 13) which has an axial section 441 extending axially from the inserting end 447, and a circumferential section 442 extending circumferentially from the axial section 441. The inner wall 448 is formed with an inner rib 449 that defines the L-shaped recess 440.

The key-operated lock 45 can be a pin tumbler lock or a disc tumbler lock. The key-operated lock 45 defines a key hole 452 for extension of a key (not shown) therein, and is formed with two axially aligned outer ribs 453 that cooperatively define a gap 454 therebetween. The axial section 441 of the L-shaped recess 440 permits extension of the outer ribs 453 therethrough so as to permit extension of the key-operated lock 45 into the inner sleeve 44 and so as to permit the inner rib 449 to extend through the gap 454 between the outer ribs 453 when the inner sleeve 44 is rotated to a predetermined angle, thereby preventing axial movement of the key-operated lock 45 relative to the inner sleeve 44.

The cam 46 includes a cam body 460, and is formed with a pair of opposing teeth 461 that project axially from the cam body 460. The cam follower 47 includes a cylindrical body 470, and is formed with a pair of opposing teeth 472 that project axially from the cylindrical body 470 and that engage the teeth 461 of the cam 46 so as to be driven by the cam 46 to move toward the front latch-driving member 481.

The cam 46 has an engaging stud 463 that is mounted movably in a radial hole 465 in the cam body 460 and that protrudes outwardly from an outer surface of the cam body 460 into the elongated opening 443 in the inner sleeve 44 to abut slidingly against the outer sleeve 433 (see FIGS. 11 and 13) so as to be retained together with the key-operated lock 45 in the lock-mounting seat 43. The engaging stud 463 is operable to move away from the elongated opening 443. The front rose 42 is formed with a second opening 422 (see FIGS. 11 and 28) that is registered with the first opening 4330 in the outer sleeve 433. The engaging stud 463 is offset from the first and second openings 4330, 422 (see FIG. 11) when the cam 46 is disposed at a locking position. The engaging stud 463 is registered with the first and second openings 4330, 422 (see FIG. 28) when the cam 46 is disposed at a predetermined angular position relative to the locking position, thereby permitting access to and operation of the engaging stud 463 to move away from the elongated opening 443 in the inner sleeve 44 and thus permitting removal of the key-operated lock 45 from the lock-mounting seat 43. In this embodiment, the engaging stud 463 is spring-biased through a biasing element 464 so as to move toward the elongated slot 443 in the inner sleeve 44 by the urging action of the biasing element 464.

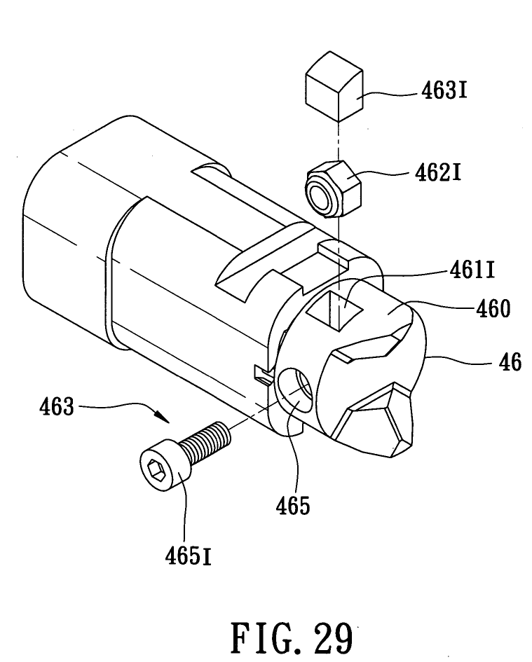

Alternatively, the engaging stud 463 can be a screw 465I (see FIG. 29) that engages the cam body 460 through a nut 462I, which is mounted in a mounting hole 461I in the cam body 460, so as to be adjustable to move toward and away from the elongated slot 443 in the inner sleeve 44. The mounting hole 461I in the cam body 460 is in spatial communication with a radial hole 465 in the cam body 460 which receives the engaging stud 463 therein. The mounting hole 461I has an open end that is covered with a block 463I.

The cam body 460 defines an axial hole 462 (see FIG. 13) and a radial hole 465 that is in spatial communication with the axial hole 462. The engaging stud 463 extends into the radial hole 465, and is formed with an engaging recess 4631 that is registered with the axial hole 462. The cam follower 47 has an engaging rod 473 that extends into the axial hole 462 to engage releasably the engaging recess 4631 in the engaging stud 463 so as to prevent retraction of the engaging stud 463 into the radial hole 465.

The cam follower 47 defines a non-circular engaging hole 474 (see FIG. 11). The front latch-driving member 48 includes a front driving rod 481, a C-shaped retainer 482, a cam-restoring spring 483, and an urging element 484. The front driving rod 481 extends through the central hole 315 in the front mounting seat 31, and has a circular rod portion 4811 that extends into the non-circular engaging hole 474 in the cam follower 47, and a non-circular rod portion 4812 that extends from the circular rod portion 4811 in a direction away from the cam follower 47. The non-circular rod portion 4812 of the front driving rod 481 is disposed outwardly of the non-circular engaging hole 474 (see FIG. 11) when the cam follower 47 is disposed at the first axial position. The non-circular rod portion 4812 of the front driving rod 481 extends into and engages releasably the non-circular engaging hole 474 (see FIG. 24) when the cam follower 47 is disposed at the second axial position.

The front driving rod 481 is mounted rotatably on the front mounding seat 31 through the C-shaped retainer 482 which engages an annular groove in the front driving rod 481 and which abuts against a periphery of the central hole 315 in the front mounting seat 31.

The swingable members 46a are driven by the front latch-driving member 48 to rotate from the locking position to the unlocking position when the front driving rod 481, is rotated from a first angular position (see FIG. 11) to a second angular position (see FIG. 24).

The cam-urging spring 483 is sleeved on the circular rod portion 4811 of the front driving rod 481 for urging the cam follower 47 to be in constant contact with the cam 46.

The urging element 484 is sleeved on the non-circular rod portion 4812 of the front driving rod 481 and has one end secured to the front mounting seat 31 and the other end secured to the front driving rod 481 for restoring the front driving rod 481 from the second angular position to the first angular position.

The front driving rod 481 is driven by the lock-mounting seat 43 to rotate from the first angular position to the second angular position when the front handle 432 of the lock-mounting seat 43 is rotated from a horizontal position (see FIG. 1) to a vertical position (not shown). An urging component 401 is sleeved on the outer sleeve 433, and has one end connected to the outer sleeve 43 and the other end connected to the front rose 42 for restoring the front handle 432 of the lock-mounting seat 43 to the horizontal position.

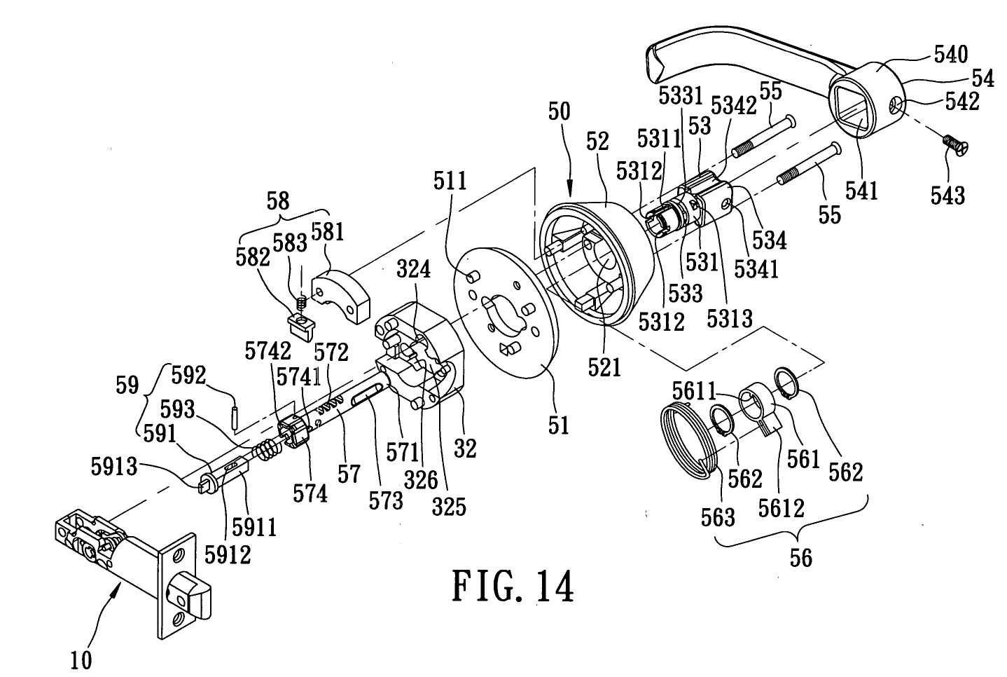

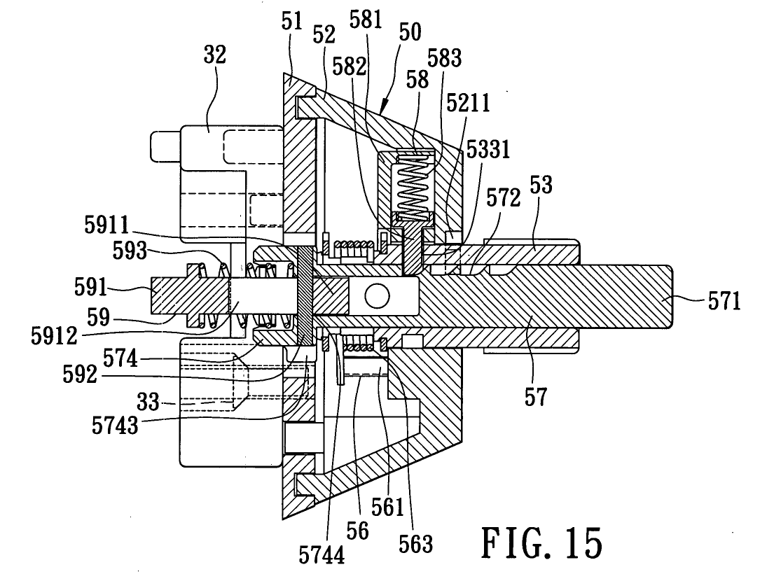

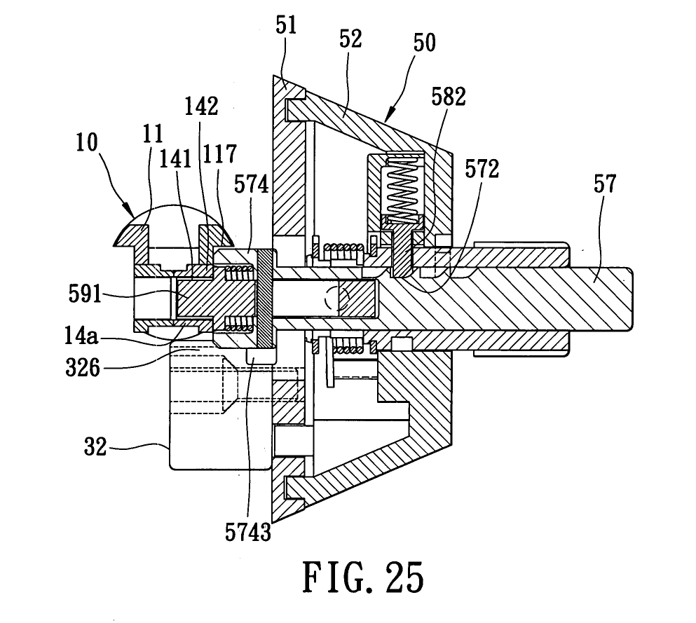

Referring to FIGS. 14 to 17, the rear actuating mechanism 50 includes a rear rose 52 with a ring-shaped base 51 adapted to be attached to the rear side of the door panel 100, a tubular handle seat 53 extending into the rear rose 52, a pushing rod 57 extending through and coupled releasably to the handle seat 53, and movable axially relative to the handle seat 53 between a holding position (see FIG. 25) and a releasing position (see FIG. 15), a positioning member 58 mounted in the rear rose 52 for positioning the pushing rod 57 at a selected one of the holding and releasing positions, and a rear latch-driving member 59 coupled to the pushing rod 57 and extending into the engaging hole 141 in the ring-shaped body 142 of a respective one of the swingable members 14a (see FIG. 25).

The ring-shaped base 51 of the rear rose 52 is formed with a plurality of positioning pins 511 for extending into the first holes 323 (see FIG. 7) in the rear mounting seat 32 for positioning on the rear mounting seat 32, and is secured to the rear mounting seat 32 through screw means 33 (see FIG. 15) for attaching to the rear side of the door panel 100.

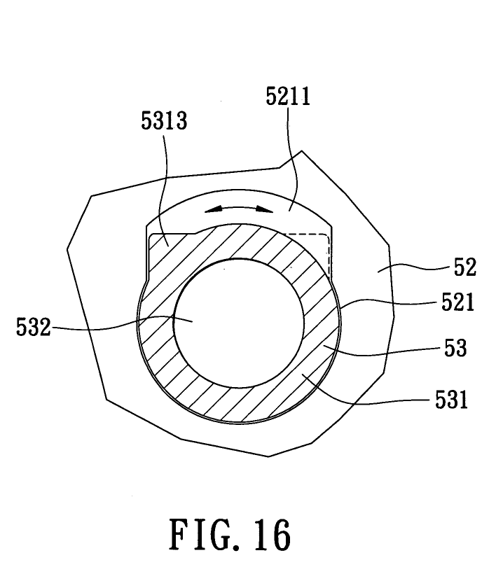

The rear rose 52 defines a central opening 521 for extension of the handle seat 53 therethrough, and a sector-shaped recess 5211 (see FIG. 16) extending from the central opening 521.

The handle seat 53 includes a tubular sleeve 531 that defines a rod-receiving channel 532 (see FIG. 16) therein, that has a first end disposed adjacent to the ring-shaped base 51 of the rear rose 52, and a second end opposite to the first end, and that is formed with an elongated axial groove 5311 extending axially from the first end, a pair of rod-engaging notches 5312 disposed on two opposite sides of the axial groove 5311 and extending axially from the first end, an annular groove 533 disposed adjacent to the second end, an aperture 5331 disposed within the annular groove 533 and in spatial communication with the rod-receiving channel 532, and a limiting protrusion 5313 disposed between the annular groove 533 and the second end and protruding therefrom into the sector-shaped recess 5211 to limit rotational range of the handle seat 53. The handle seat 53 further includes a generally rectangular sleeve 534 that extends from the second end of the tubular sleeve 531 and that is formed with a threaded hole 5341 and a pair of axially extending grooves 5342.

A rear handle 54 includes a connecting part 540 that is formed with a rectangular hole 541 which receives fittingly the rectangular sleeve 534 therein, and a side hole 542 which is registered with the threaded hole 5341 in the rectangular sleeve 534. The rear handle 54 is detachably secured to the rectangular sleeve 534 through a screw 543 which extends through the side hole 542 in the connecting part 540 and which engages threadedly the threaded hole 5341 in the rectangular sleeve 534. As such, rotation of the rear handle 54 results in co-rotation of the handle seat 533.

Two fastening screws 55 extend respectively through the rear mounting seat 32 and the latch mechanism 10 to engage the threaded holes 316 in the front mounting seat 31 (see FIG. 7) so as to fasten the front and rear mounting seats 31, 32 and the rear actuating mechanism 50 together. The fastening screws 55 are hidden behind the rectangular sleeve 534, and are exposed and are accessable through the axially extending grooves 5342 in the rectangular sleeve 534 only when the handle 54 is rotated to a predetermined angle. As a consequence, in case the front actuating mechanism 40 was broken by a thief, the latch mechanism 10 and the rear actuating mechanism 50 can still function.

The rear actuating mechanism 50 further includes a restoring unit 56 that has a holding seat 561, a pair of C-shaped retainers 562, and a handle-restoring spring 563. The holding seat 561 is sleeved on the tubular sleeve 531, is confined thereat by the C-shaped retainers 562, and is formed with a radial protrusion 5611 that extends into the axial groove 5311 in the tubular sleeve 531 so as to couple the handle seat 53 to the holding seat 561, and a clamping part 5612 extending radially and outwardly therefrom. The handle-restoring spring 563 has one end abutting against the rear rose 52 and the other end clamped by the clamping part 5612 so as to permit restoration of the rear handle 54 to its normal position.

The pushing rod 57 extends through the rod-receiving channel 532 in the tubular sleeve 531, and has a pressing end portion 571 extending outwardly through the connecting part 540 of the rear handle 54, and a generally rectangular engaging end portion 574 that is opposite to the pressing end portion 571 and that is disposed adjacent to a respective one of the swingable members 14a. The pushing rod 47 is formed with a plurality of retaining grooves 572 between the pressing end portion 571 and the engaging end portion 574, and an elongated recess 573 that is registered with the side hole 542 in the connecting part 540 for extension of the screw 543 therein. A pair of opposing protrusions 5741 project from the pushing rod 57, are disposed adjacent to the engaging end portion 574 of the pushing rod 57, and extend respectively into the rod-engaging notches 5312 in the tubular sleeve 531 so as to couple the pushing rod 57 to the handle seat 53. The engaging end portion 574 defines a rectangular hole 5744 (see FIG. 15), is formed with an engaging protrusion 5743 that projects therefrom, and has four corners, each of which is formed with an engaging notch 5742.

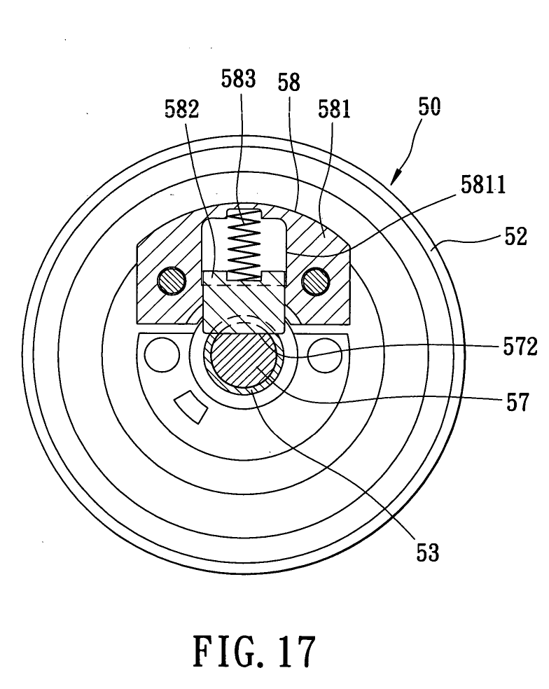

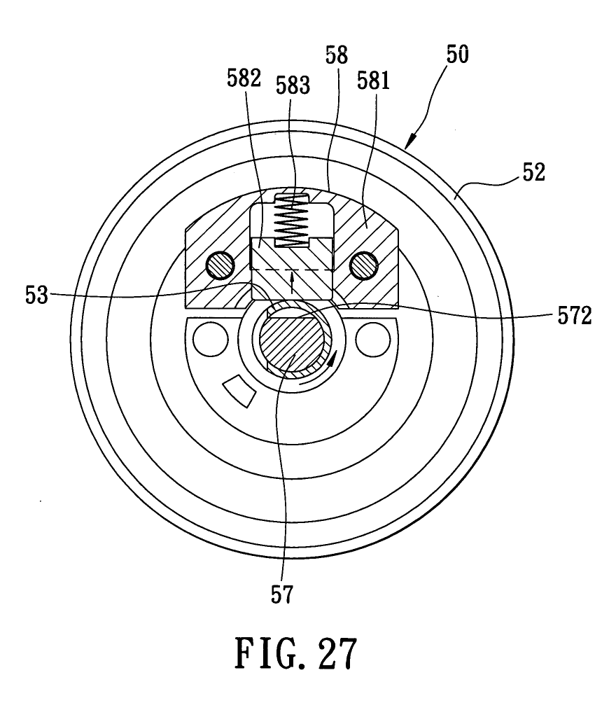

The positioning member 58 is disposed on the tubular sleeve 531, and includes a mounting seat 581, a spring-biased positioning block 582, and an urging spring 583. The mounting seat 581 defines an inner space 5811 for receiving the positioning block 582 therein. The positioning block 582 extends through the annular groove 533 and the aperture 5331 in the tubular sleeve 531, and is movable radially relative to the pushing rod 57 between a lower position (see FIGS. 15 and 17), in which the positioning block 582 extends into and engages a selected one of the retaining grooves 572, and an upper position (see FIG. 27), in which the positioning block 582 disengages the selected one of the retaining grooves 572. The urging spring 583 is mounted in the mounting seat 581 for urging the positioning block 582 to move toward the pushing rod 57.

The rear latch-driving member 59 includes a rear driving rod 591, a limiting pin 592, and a rod-restoring spring 593. The rear driving rod 591 includes an elongated rectangular body 5911 that extends into the rectangular hole 5744 in the engaging end portion 574 of the pushing rod 57 so as to permit co-rotation of the rear driving rod 591 and the pushing rod 57, and that is formed with an elongated slot 5912. The limiting pin 592 extends through the engaging end portion 574 of the pushing rod 57 and into the elongated slot 5912 in the elongated rectangular body 5911 so as to limit axial movement of the pushing rod 57 relative to the rear driving rod 591. The rear driving rod 591 further includes an inserting end 5913 that extends from the rectangular body 5911 and that extends into the engaging hole 141 in the ring-shaped body 142 of the respective one of the swingable members 14a. The rod-restoring spring 593 is sleeved on the rectangular body 5911 of the rear driving rod 591 for urging the pushing rod 57 to move from the holding position to the releasing position.

The engaging end portion 574 of the pushing rod 57 is disposed outwardly of and disengages the non-circular recess 117 in the respective one of the second walls 1102 of the hollow mounting body 11 of the latch mechanism 10 when the pushing rod 57 is disposed at the releasing position, and is received in and engages the non-circular recess 117 (see FIG. 25) in the respective one of the second walls 1102 of the hollow mounting body 11 of the latch mechanism 10 when the pushing rod 57 is disposed at the holding position, thereby preventing rotation of the pushing rod 57.

The stopping protrusion 143 of one of the swingable members 14a, which is disposed adjacent to the engaging end portion 574 of the pushing rod 57, is disposed outwardly of the engaging notches 5742 in the corners of the engaging end 574 of the pushing rod 57 when the pushing rod 57 is disposed at the releasing position, and extends into and engages the engaging notch 5742 in one of the corners of the engaging end portion 574 of the pushing rod 57 when the pushing rod 57 is disposed at the holding position, thereby immobilizing the driving unit 14.

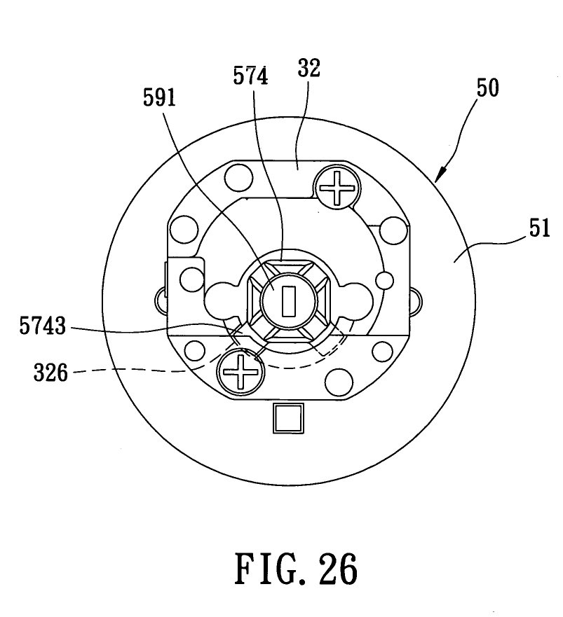

The engaging protrusion 5743 of the pushing rod 57 is disposed outwardly of the rod-engaging groove 326 (see FIG. 7) in the rear mounting seat 32 when the pushing rod 57 is disposed at the releasing position, and extends into and engages the rod-engaging groove 326 in the rear mounting seat 32 (see FIGS. 25 and 26) when the pushing rod 57 is disposed at the holding position.

Operation of the door lock assembly of this invention will now be described in the following paragraphs.

Operation of the Latch Mechanism

Referring to FIGS. 3 and 6, when the door panel 100 is locked on the door frame 200, the contact plate 111 of the hollow mounting body 11 of the latch mechanism 10 abuts against the strike plate 24 of the socket 20, the shank portion 121 of the latch bolt 12 is received in the socket 20, the engaging balls 12c engage the engaging grooves 22 in the socket 20, and the end 153 of the stopping linkage 15c can be stopped by the stopper 116, thereby securing the locking of the door panel 100 on the door frame 200 and preventing occurrence of lock-picking.

To open the door panel 100, referring to FIGS. 1, and 18 to 21, the swingable members 14a are driven by a key (not shown) and the front handle 432 or by the rear handle 54 to rotate from the locking position to the unlocking position. During rotation of the swingable members 14a from the locking position to the unlocking position, the pushing lever 15a is pulled first by the driving unit 14 to move relative to the latch bolt 12 to allow the engaging balls 12c to disengage from the engaging grooves 22 in the socket 20, and the positioning pin 14c is moved outwardly of the front retaining recesses 114 to disengage from the front retaining recesses 114 (see FIGS. 18 and 19). The end 153 of the stopping linkage 15c is subsequently moved along the curved path to pass over the stopper 116 by virtue of the curved movement of the cranks 15d, and the shank portion 121 of the latch bolt 12 is fully received in the hollow mounting body 11 with the positioning pin 14c received in the retaining recesses 115 in the hollow mounting body 11 (see FIGS. 20 and 21).

Referring to FIGS. 22 and 23, when the door panel 100 is moved to the door frame 200, the tapered end portion 122 of the latch bolt 12 strikes the strike plate 24 of the socket 20, which results in retraction of the latch bolt 12 from the first retracted position toward the second retracted position. During retraction of the latch bolt 12 from the first retracted position to the second retracted position, the positioning pin 14c is moved along the elongated slots 144 in the pin-supporting arms 145 of the swingable members 14a to disengage from the rear retaining recesses 115, which permits subsequent automatic restoring of the latch bolt 12 from the second retracted position to the extended position by the urging action of the urging member 14b.

Operation of the Front Actuating Mechanism

Referring to FIG. 24, when the user wishes to open the door panel 100 from the outside, the key is inserted into the key hole 452 in the key-operated lock 45 to drive the cam 46 to rotate so that the cam follower 47 is driven by the cam 46 to couple with the front driving rod 481. The lock-mounting seat 43 is subsequently rotated by turning the front handle 432 to drive the front driving rod 481 through the cam follower 47 so as to move the swingable members 14a from the locking position to the unlocking position.

Operation of the Rear Actuating Mechanism

Referring to FIGS. 1, 2 and 14, when the user wishes to open the door panel 100 from the inside, he or she can open the door panel 100 directly by turning the rear handle 54. Rotation of the rear handle 54 results in co-rotation of the handle seat 53, which, in turn, results in co-rotation of the pushing rod 57 and the rear driving rod 591, and thus rotation of the swingable members 14a from the locking position to the unlocking position.

Operation of the Pushing Rod

Referring to FIGS. 25 and 26, when the pushing rod 57 is pushed by the user, the engaging end portion 574 of the pushing rod 57 is moved into the non-circular recess 117 in the respective one of the second walls 1102 of the hollow mounting body 11, which prevents the pushing rod 57 from rotation. The protrusions 5741 of the pushing rod 57 disengage from the rod-engaging notches 5312 in the tubular sleeve 531 of the lock-mounting seat 53. The pushing rod 57 is positioned at the holding position by the positioning block 582 of the positioning member 58. The engaging notch 5742 in one of the corners of the engaging end portion 574 of the pushing rod 57 engages the stopping protrusion 143 of the respective swingable member 14a. The engaging protrusion 5743 of the pushing rod 57 extends into and engages the engaging recess 326 in the rear mounting seat 32, thereby locking the driving unit 14. The locking operation of the driving unit 14 provides the following functions:

1. The latch bolt 12 cannot be moved from the extended position to the first retracted position from the outside by using the key, even when the front actuating mechanism 40 is picked.

2. When the latch bolt 12 is disposed at the first retracted position while the driving unit 14 is locked, the latch bolt 12 can be maintained at the first retracted position. Under this condition, the latch bolt 12 can be retracted from the first retracted position to the second retracted position when the tapered end portion 122 of the latch bolt 12 strikes the strike plate 24 during closing or opening of the door panel 100.

To unlock the driving unit 14, the rear handle 54 is rotated. Since the pushing rod 57 has been disengaged from the handle seat 53, rotation of the rear handle 54 will not result in rotation of the pushing rod 57 and the rear driving rod 591, but will result in upward movement of the positioning block 582 which is in sliding contact with a groove-defining wall of the annular groove 533 in the tubular sleeve 531, which will then result in disengagement between the pushing rod 57 and the positioning block 582, which, in turn, will results in axial movement of the pushing rod 57 by the urging action of the rod-restoring spring 593 from the holding position to the releasing position.

Removal of the Key-Operated Lock

Referring to FIG. 28, the key-operated lock 45 can be removed from the lock-mounting seat 53 by using the key and a tool 500. When the engaging stud 463 is rotated together with the cam 46 by the key to the aforesaid predetermined angular position, the engaging stud 463 is registered with the first and second openings 4330, 422 and can be accessed and be pushed by the tool 500 so as to move away from the elongated slot 443 in the inner sleeve 44 and so as to permit removal of the key-operated lock 45 from the lock-mounting seat 53.

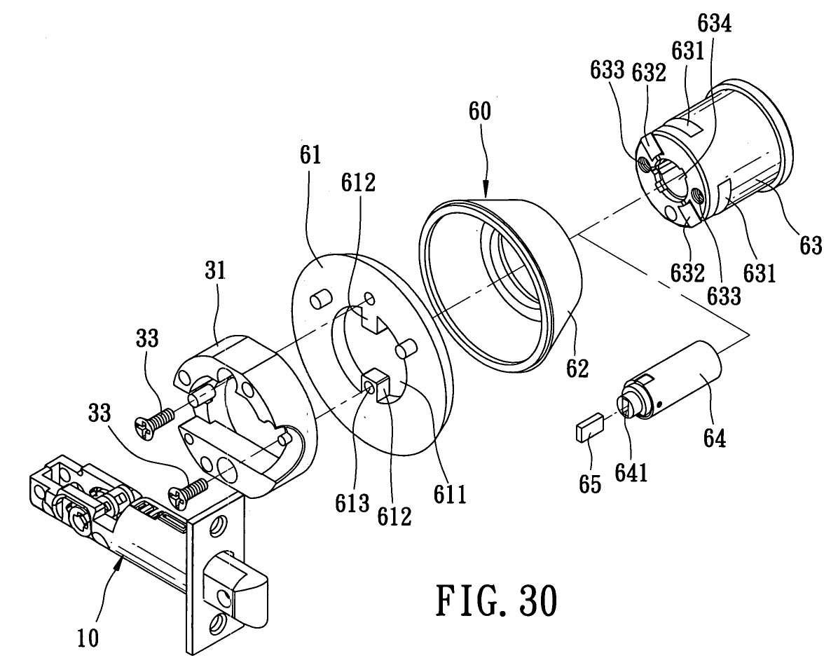

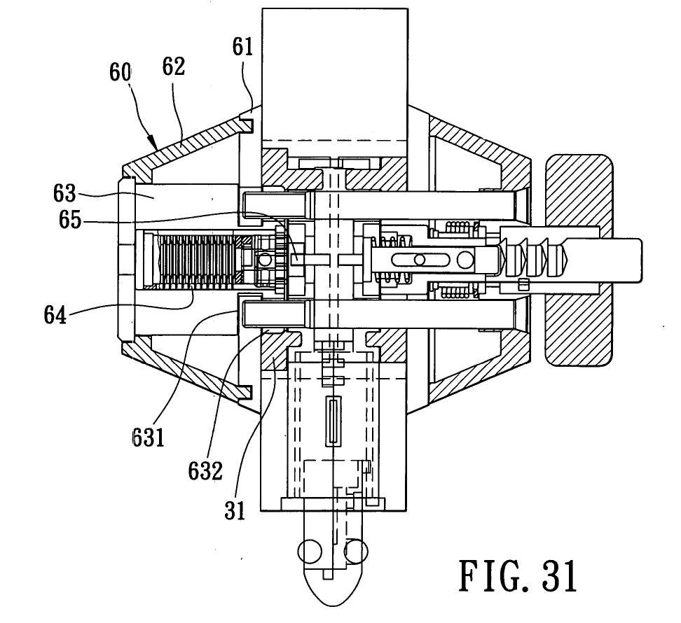

FIGS. 30 and 31 illustrate the second preferred embodiment according to this invention, which includes a front actuating mechanism 60 that differs from the front actuating mechanism 40 of the first preferred embodiment. In this embodiment, the ring-shaped base 61 of the front rose 62 is disposed between the front mounting seat 31 and the lock-mounting seat 63, defines a central opening 611, and is formed with a pair of diametrically opposite positioning studs 612, each of which projects into the central opening 611 and each of which is formed with a through-hole 613. The lock-mounting seat 63 is formed with a pair of diametrically disposed screw holes 633, a pair of diametrically disposed axial slots 632, and a pair of circumferential slots 631 that extend respectively and circumferentially from the axial slots 632 and that are axially and respectively aligned with the screw holes 633. The axial slots 632 permit extension of the positioning studs 612 therethrough and respectively into the circumferential slots 631 upon rotation of the lock-mounting seat 63 to a predetermined angle so as to permit coupling of the ring-shaped base 61 to the lock-mounting seat 63 and so as to permit alignment of the screw holes 633 in the lock-mounting seat 63 with the through-holes 613 in the positioning studs 612, respectively. The front actuating mechanism 60 further includes a pair of screws 33 that extend through the front mounting seat 31 and the through-holes 613 in the positioning studs 612 to engage threadedly the screw holes 633 in the lock-mounting seat 63 so as to secure the lock-mounting seat 63 and the front rose 62 to the front mounting seat 31. The lock-mounting seat 63 defines a central hole 634 for receiving the key-operated lock 64. The key-operated lock 64 has a mounting end that defines a rectangular hole 641 for insertion of the front driving rod 65 therein.

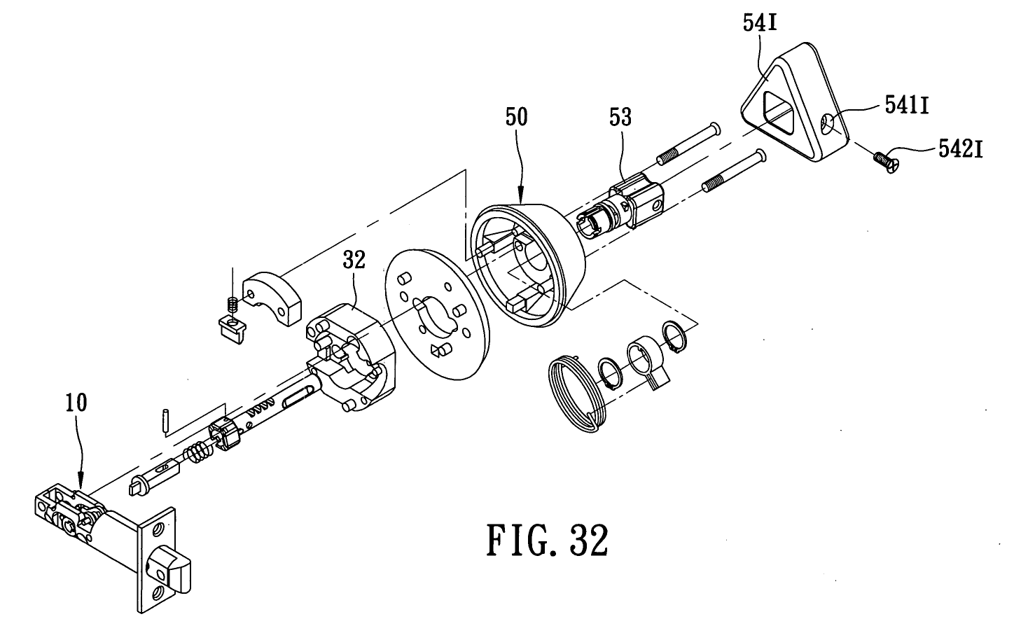

FIG. 32 illustrates the third preferred embodiment according to this invention, which includes a rear actuating mechanism 50I that differs from the rear actuating mechanism 50 of the first embodiment. In this embodiment, the rear handle 54I is triangular in shape, and is formed with a side hole 541I for extension of the screw 542I which engages threadedly the handle seat 53.

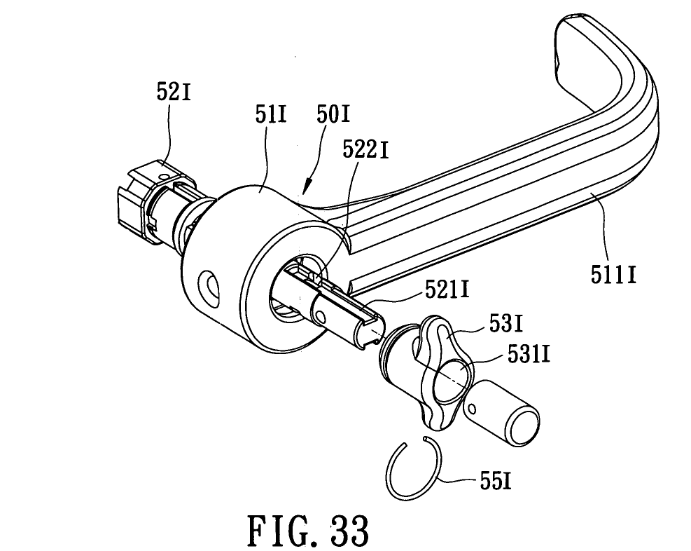

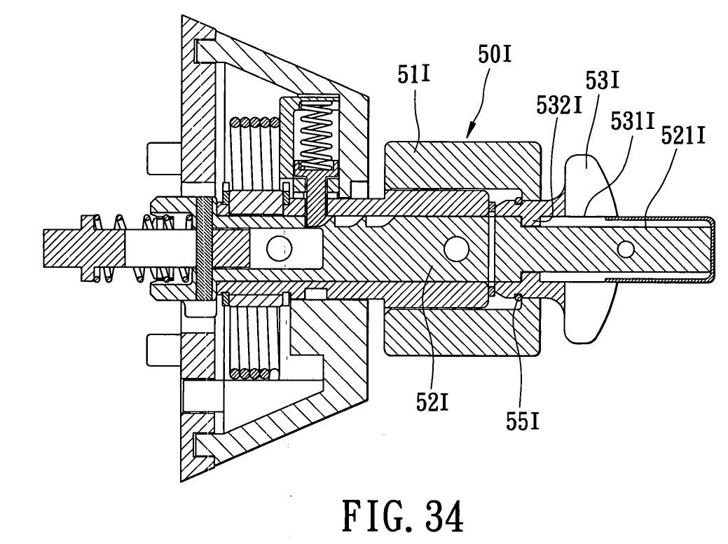

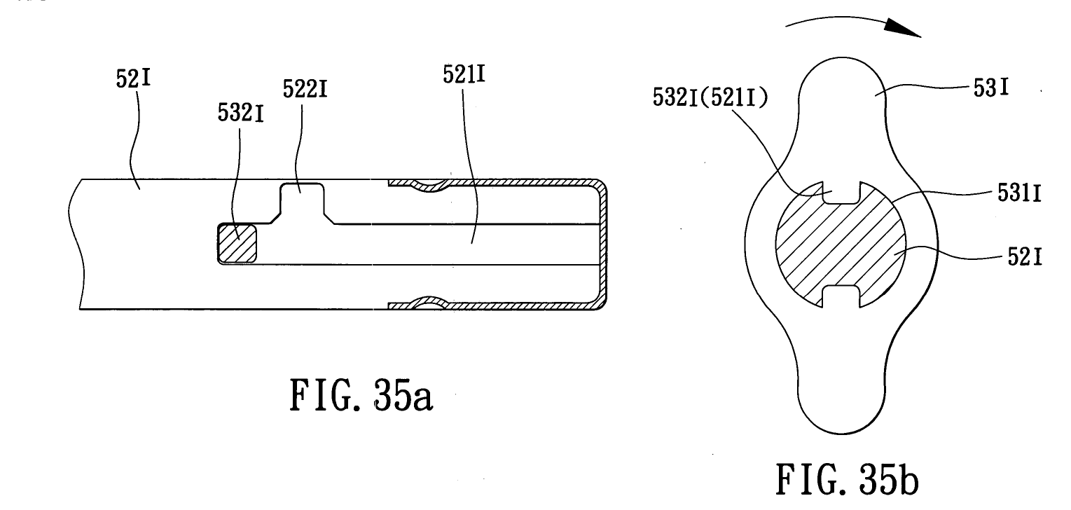

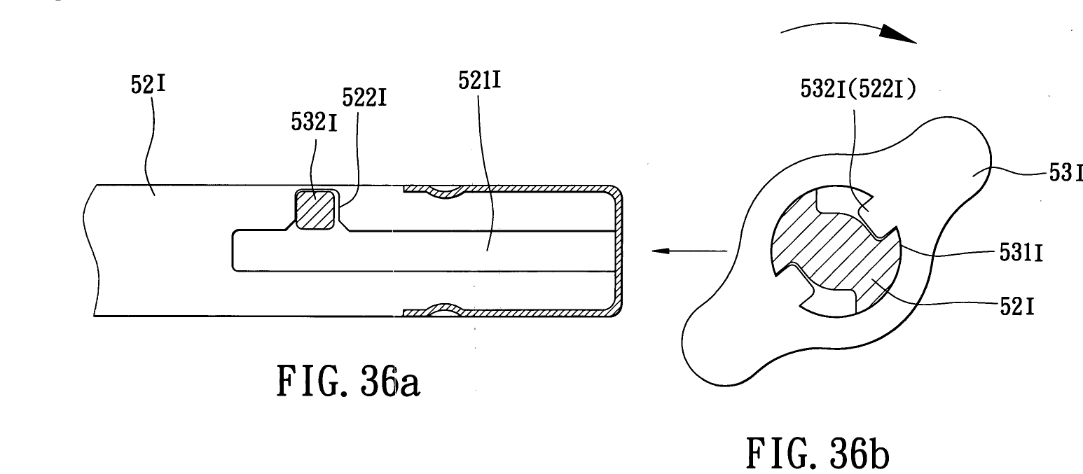

FIGS. 33 and 34 illustrate the fourth preferred embodiment according to this invention, which includes a rear actuating mechanism 50I that differs from the rear actuating mechanism 50 of the first preferred embodiment. In this embodiment, the rear actuating mechanism 50I further includes a locking button 53I mounted coaxially and rotatably on the handle seat 51I through a C-shaped retainer 55I. The pushing rod 52I extends coaxially through the locking button 53I, and is formed with an axially extending groove 521I that extends along the length of the pushing rod 52I and that is defined by a groove-defining wall which is formed with at least a retaining indentation 522I. The locking button 53I defines a central hole 531I for extension of the pushing rod 52I therethrough, and is formed with at least a locking protrusion 532I that protrudes into the central hole 531I and the axially extending groove 521I in the pushing rod 52I. The locking protrusion 532I is axially offset from the retaining indentation 522I (see FIGS. 35a and 35b) when the pushing rod 52I is disposed at the releasing position, and is radially aligned with the retaining indentation 522I (see FIGS. 36a and 36b) when the pushing rod 52I is disposed at the holding position. The locking button 53I is rotatable relative to the pushing rod 52I from a non-retaining position to a retaining position (see FIGS. 36a and 36b), in which the locking protrusion 532I is received in the retaining indentation 522I, when the pushing rod 52I is disposed at the holding position, thereby preventing axial movement of the pushing rod 52I from the holding position to the releasing position and movement of the latch bolt 10 from the extended position to the first retracted position. Under this condition, even rotation of the rear handle 511I does not result in unlatching of the latch bolt 10.

The inclusion of the locking button 53I has advantages as follows:

1. Since the rear handle 511I can be easily accessed by a thief when the door panel 100 is drilled and a hole is formed in the door panel 100, and since the locking button 53I is hidden behind the handle seat 51I, the locking button 53I can prevent the thief from opening the door panel 100 through the rear handle 511I.

2. When the latch bolt 10 is maintained at the first retracted position for convenience purposes with the pushing rod 52I disposed at the holding position, the door panel 100 can be opened without the key and be closed automatically. Under this condition, the locking button 53I can prevent movement of the pushing rod 52I from the holding position to the releasing position when the rear handle 511I is rotated, thereby maintaining the latch bolt 12 at the first retracted position.

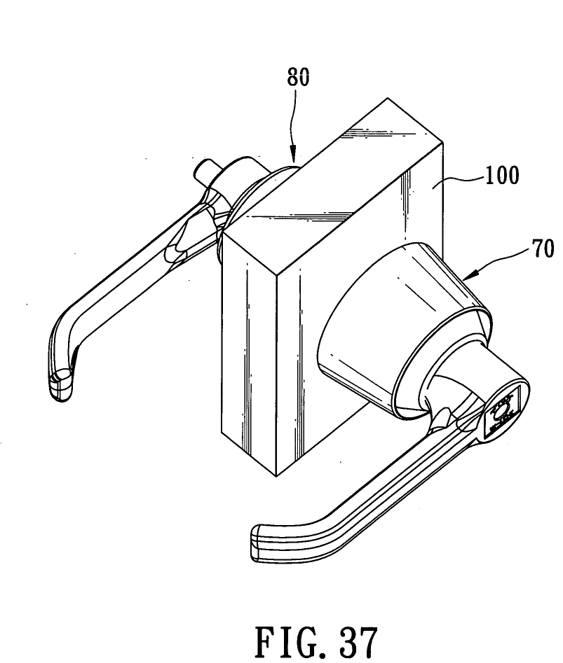

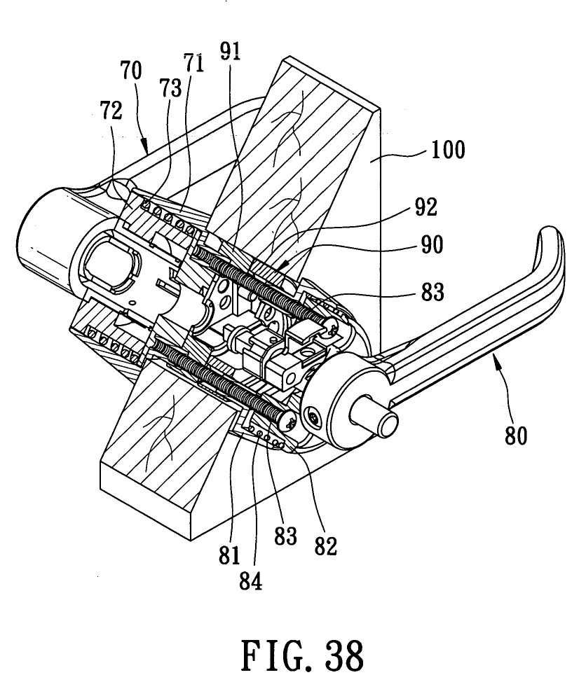

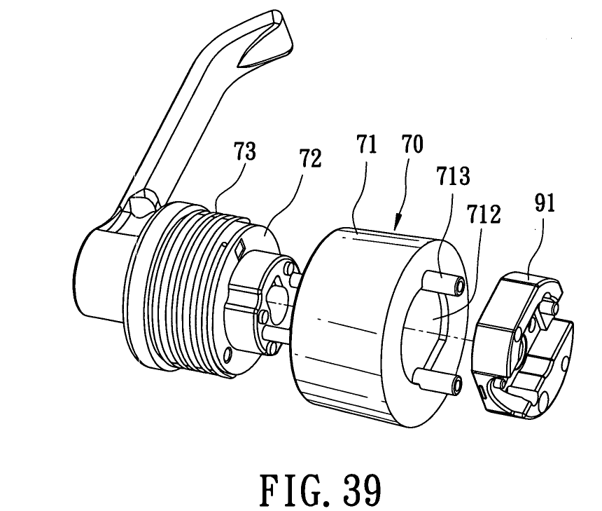

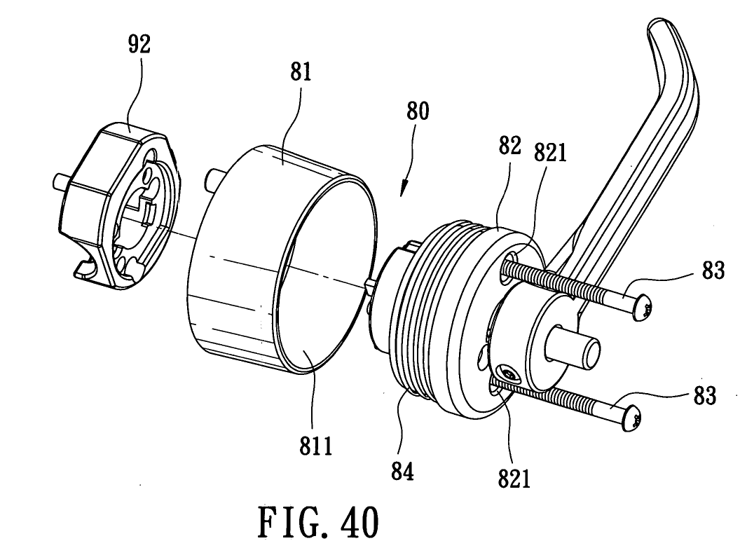

FIGS. 37 to 40 illustrate the fifth preferred embodiment according to this invention, which includes front and rear actuating mechanism 70, 80 that differ from the front and rear actuating mechanisms 40, 50 of the first preferred embodiment.

The front actuating mechanism 70 includes a front rose 71 defining a central hole 712 therein, a lock-mounting seat 72 extending through the central hole 712 to connect with the front mounting seat 91 of the mounting mechanism 90, and an urging spring 73 sleeved on the lock-mounting seat 72. The front rose 71 is formed with a pair of axially extending threaded posts 713 that extend into the door panel 100.

The rear actuating mechanism 80 includes a rear rose 81, a handle seat 82, a pair of screw rods 83, and a biasing member 84. The rear rose 81 defines a central hole 811 for extension of the handle seat 82 therethrough. The handle seat 82 is secured to the rear mounting seat 92 of the mounting mechanism 90, and is formed with a pair of through-holes 821 for extension of the screw rods 83 therethrough. The screw rods 83 engage threadedly and respectively the threaded posts 713 of the front rose 71. The biasing member 84 is sleeved on the handle seat 82 for urging the rear rose 81 to abut against the rear side of the door panel 100. The depth that the screw rods 83 extend in the threaded posts 713 can be adjusted so as to permit the door lock assembly of this invention to be used with door panels having different thickness.

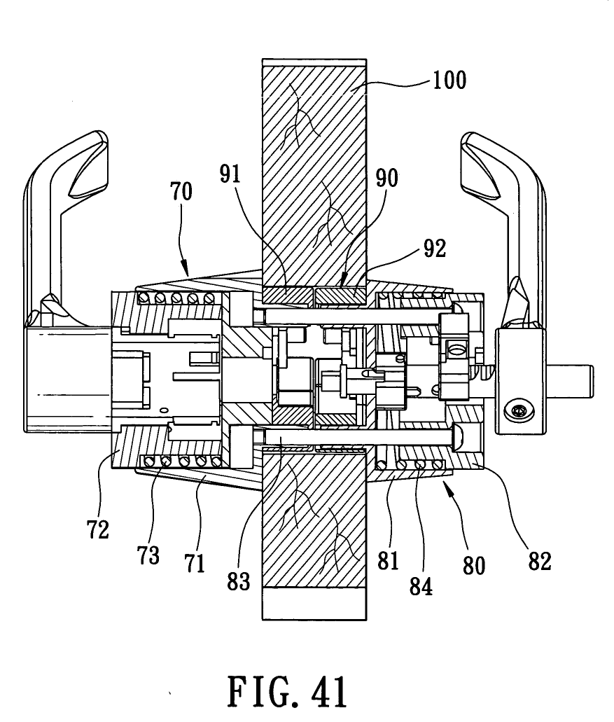

Referring to FIG. 41, when the door lock assembly of this invention is to be mounted on a thin door panel 100I, the depth that the screw rods 83 extend in the threaded posts 713 is adjusted such that the front and rear roses 71, 81 abut respectively against the front and rear sides of the door panel 100 and that a front end portion of the lock-mounting seat 72 and a rear end portion of the handle seat 82 will protrude outwardly and respectively from the front and rear roses 71, 81.

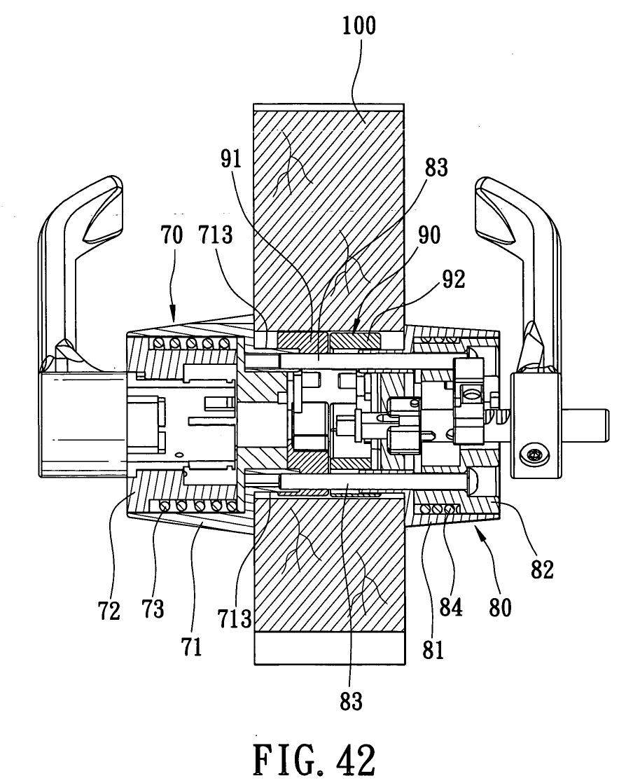

Referring to FIG. 42, when the door lock assembly of this invention is to be mounted on a thick door panel 100, the depth that the screw rods 83 extend in the threaded posts 713 is adjusted such that the front and rear roses 71, 81 abut respectively against the front and rear sides of the door panel 100 and that a front end face of the lock-mounting seat 72 and a rear end face of the handle seat 82 are flush respectively a front end face of the front rose 71 and a rear end face of the rear rose 81, respectively.

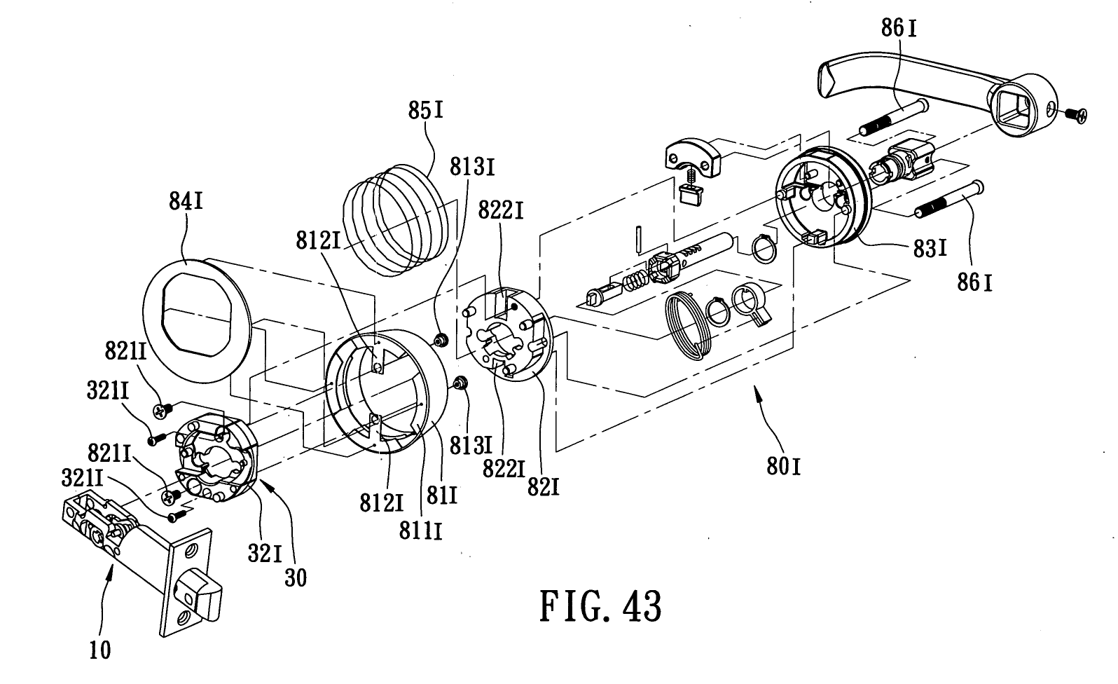

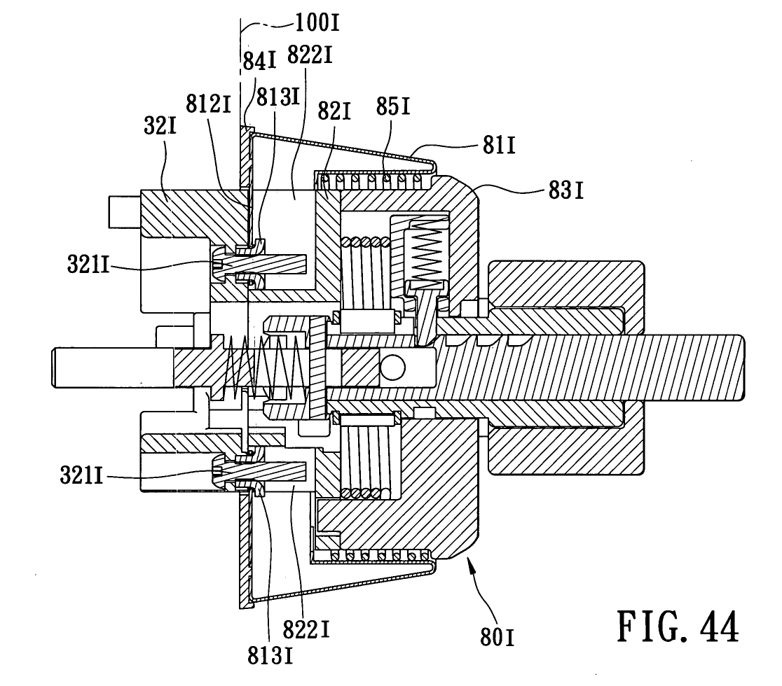

FIGS. 43, 44, and 46 illustrate the sixth preferred embodiment according to this invention, which includes front and rear actuating mechanisms 70I, 80I that differ from the front and rear actuating mechanisms 40, 50 of the first preferred embodiment. In this embodiment, the front and rear mounting seats 31I, 32I sandwich the latch mechanism 10 therebetween, and are disposed between the front and rear actuating mechanisms 70I, 80I. As illustrated in FIG. 43, the rear rose 81I has a plurality of angularly disposed end plates 811I, two radially extending rear legs 812I that are disposed adjacent to the rear mounting seat 32I, and two rear threaded elements 813I that are secured to the radially extending rear legs 812I. The rear actuating mechanism 80I further includes a handle seat 83I that is received in the rear rose 82I, and two rear adjusting screws 321I that extend through and that abut against the rear mounting seat 32I and that engage threadedly and respectively the rear threaded elements 813I so as to permit adjustment of a distance between the rear mounting seat 32I and the rear rose 81I.

A rear pad 84I is disposed between the door panel 100I and the rear rose 81I. A ring-shaped base 82I is received in the front rose 81I and is secured to the rear mounting seat 32I through a pair of screws 821I. The ring-shaped based 82I is formed with a pair of axially extending grooves 822I that receive the rear legs 812I of the rear rose 81I therein, respectively, so as to permit axial movement of the rear legs 812I therewithin. A rear urging spring 85I is sleeved on the handle seat 83I and the ring-shaped base 82I for urging the rear rose 81I to abut against the door panel 100I. The handle seat 83I is secured to the ring-shaped base 82I through a pair of screw rods 86I.

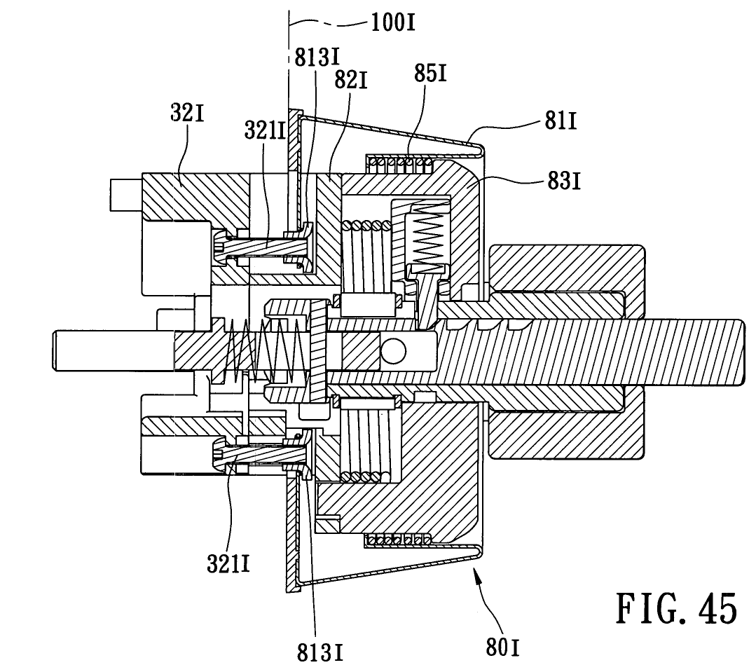

Referring to FIG. 45, when the door lock assembly of this invention is to be mounted on a thick door panel 100I, the rear adjusting screws 321I can be adjusted such that the distance between the rear rose 81I and the rear mounting seat 32I is the same as the thickness of the door panel 100I.

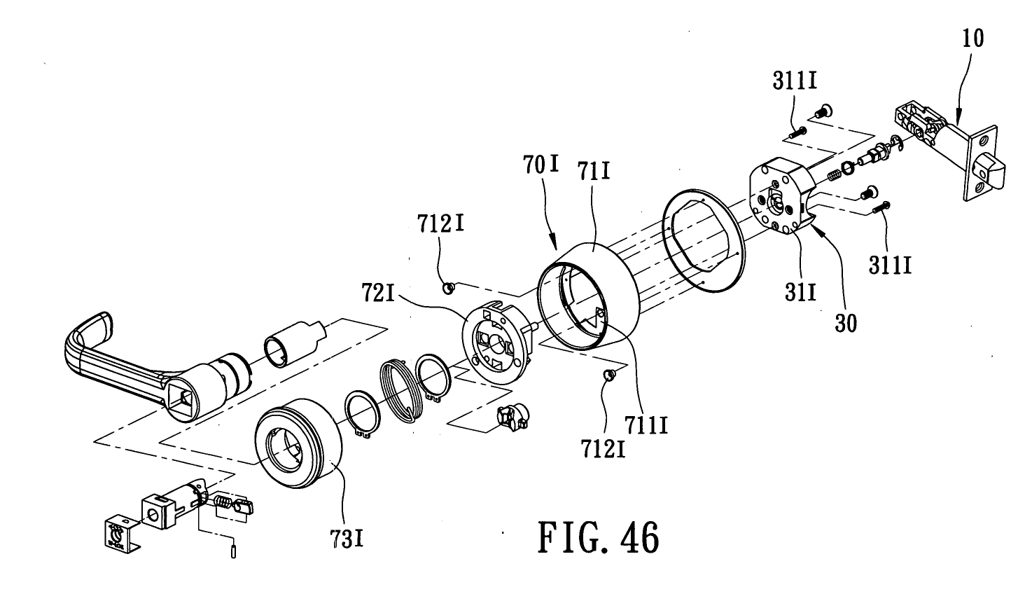

In a similar way, as illustrated in FIG. 46, the front actuating mechanism 70I includes a ring-shaped base 72I, a lock-mounting seat 73I, a front rose 71I having two radially extending front legs 711I that are disposed adjacent to the front mounting seat 31I, and two front threaded elements 712I that are secured to the radially extending front legs 711I. The front actuating mechanism 70I further includes two front adjusting screws 311I that extend through and that abut against the front mounting seat 31I and that engage threadedly and respectively the front threaded elements 712I so as to permit adjustment of a distance between the front mounting seat 31I and the front rose 71I.

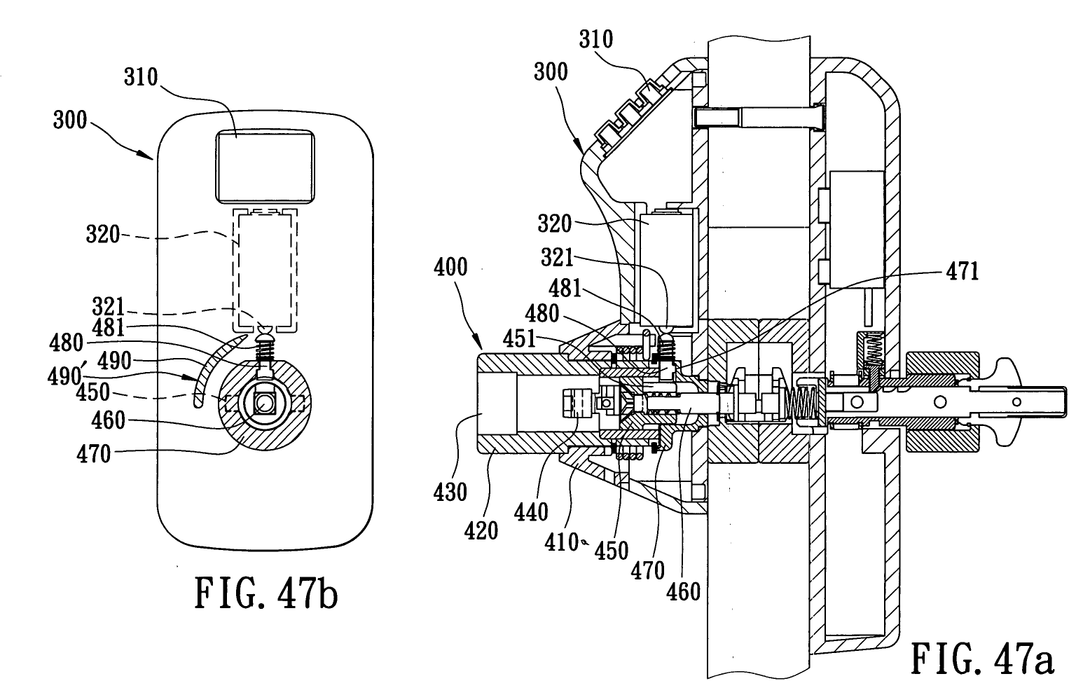

FIGS. 47a and 47b illustrate the seventh preferred embodiment according to this invention, which differs from the previous embodiments by further including a control unit 300.

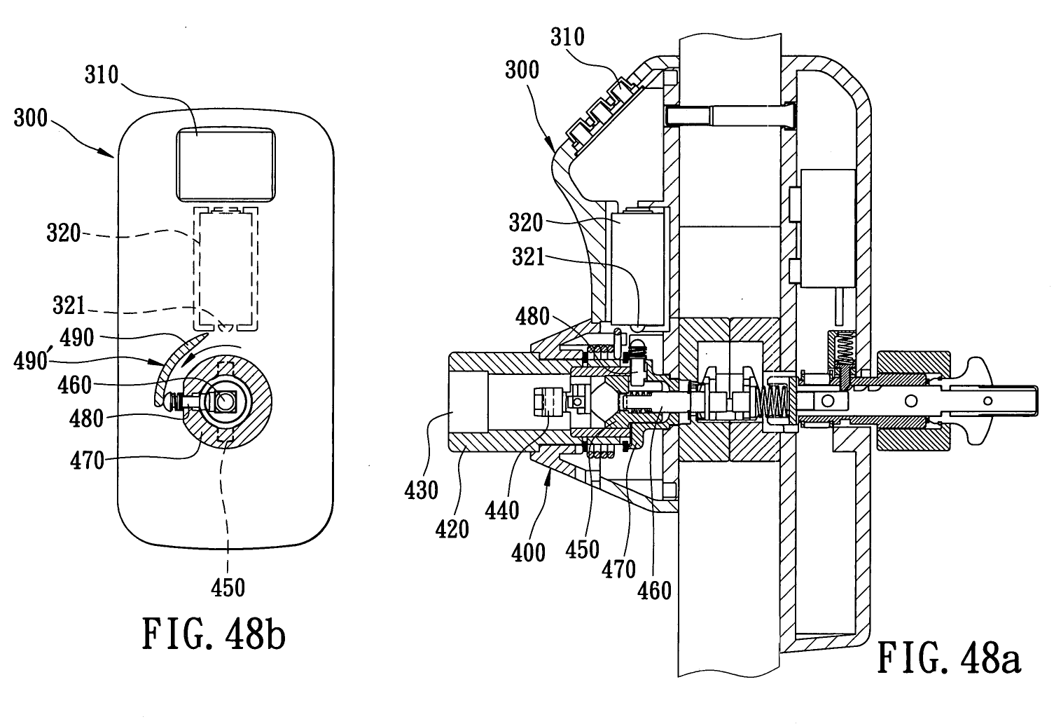

In this embodiment, the front actuating mechanism 400 includes a front rose 410, a lock-mounting seat 420, a lock 430, a cam 440, a cam follower 450, a front latch-driving member 460, a coupler 470, a driving rod 480, and a retaining member 490′. The coupler 470 is sleeved on the front latch-driving member 460 so as to be co-rotatable therewith and is formed with a slide hole 471 that is registered with an engaging hole 451 in the cam follower 450 and that receives the driving rod 480 therein. The control unit 300 includes a control panel 310, and an electromagnetic valve 320 with a pushing member 321 which is registered with the driving rod 480 and which is controlled by the control panel 310 to move toward and away from the driving rod 480. The driving rod 480 is driven by the pushing member 321 to move from a first radial position (see FIG. 47a) in which the driving rod 480 is disposed outwardly of the engaging hole 451 in the cam follower 450, to a second radial position (see FIG. 48a), in which the driving rod 480 extends into the engaging hole 451 in the cam follower 450 so as to couple the cam follower 450 to the front latch-driving member 460. A restoring spring 481 is sleeved on the driving rod 480 for urging the driving rod 480 to move from the second radial position to the first radial position.

The retaining member 490′ includes a curved wall 490 that is spaced apart from and that surrounds the coupler 470 in such a manner to permit sliding abutment of the driving rod 480 against the curved wall 490 when the driving rod 480 is rotated together with the coupler 470 so as to retain the driving rod 480 in the slide hole 471.

Witt the inclusion of the control unit 300, the coupler 470 and the driving rod 480 in the door lock assembly of this invention, the latch bolt 10 can be unlocked by using either the key or the control unit 300.

FIG. 48 illustrates how the latch bolt 10 is unlocked by using a key (not shown). The cam follower 450 is moved to couple with the front latch-driving member 460 when actuated by the key, thereby permitting the front-latch driving member 460 to be driven by the front handle (not shown) of the lock-mounting seat 420.

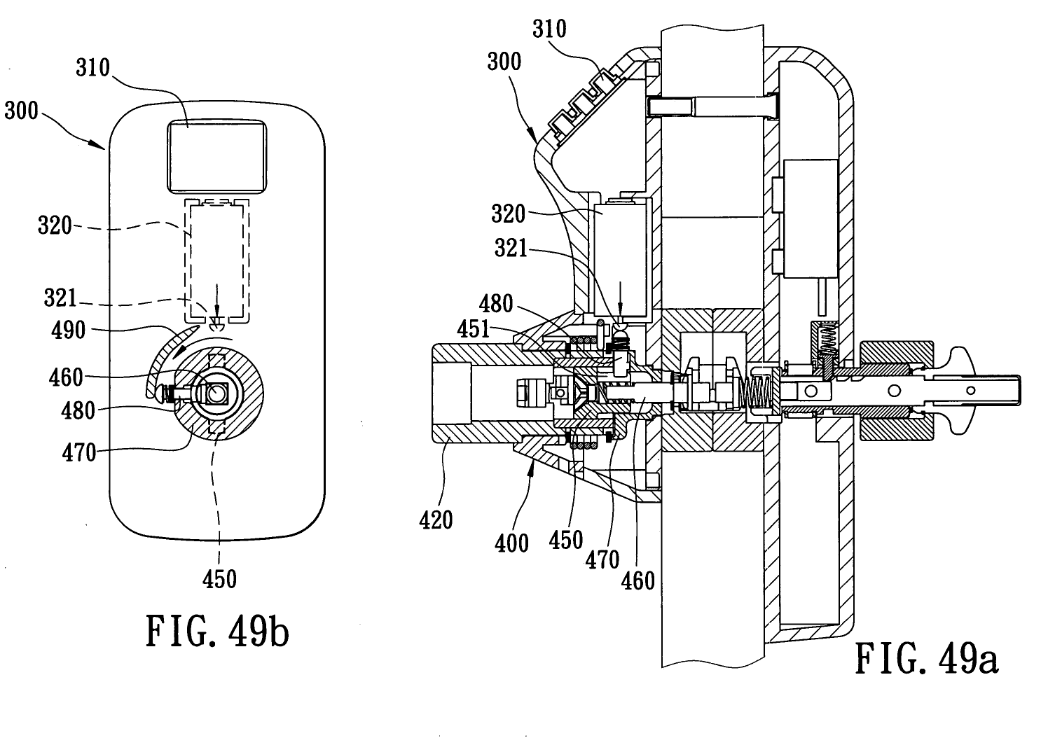

FIG. 49 illustrates how the latch bolt 10 is unlocked by using the control unit 300. The coupler 470 is coupled to the cam follower 450 when the driving rod 480 is moved into the engaging hole 451 in the cam follower 450 by the pushing member 321 upon actuation of the electromagnetic valve 320, thereby permitting the front-latch driving member 460 to be driven by the front handle (not shown) of the lock-mounting seat 420.

The following are some of the advantages of the door lock assembly of this invention: (1) the configuration of the latch bolt 10 can effectively prevent picking; (2) the door panel 100 can be freely opened and closed; (3) the front and rear mounting seats 31, 32 are made from a relatively high hardness material which is resistant to drilling; (4) the screw rods 83 or the front and rear adjusting screws 311I, 321I permit the assembly to be used in door panels having different thicknesses; (5) the rear and front urging springs 73, 84 permit the front and rear roses 71, 81 to abut against the front and rear sides of the door panel 100; (6) the front and rear latch-driving members 481, 591 are independent from each other so that when the front actuating mechanism 40 is picked and is damaged, the latch mechanism 10 and the rear actuating mechanism 50 can still work; and (7) in case the key-operated lock 45 is damaged, it can be replaced conveniently instead of involving replacement of the entire front actuating mechanism as required in the conventional door lock assembly.

With the invention thus explained, it is apparent that various modifications and variations can be made without departing from the spirit of the present invention.

I claim:

1. A door lock assembly for locking a door panel to a door frame, said door lock assembly comprising:
a first engaging member adapted to be secured in a socket in the door frame; and
a latch mechanism including
a hollow mounting body adapted to be mounted on the door panel, and
a latch unit including a latch bolt that is retractable telescopically into said hollow mounting body, and that is operable to move relative to said hollow mounting body in a longitudinal direction from a first retracted position to an extended position, in which said latch bolt is capable of extending into the socket, said latch unit further including a second engaging member that is mounted movably on said latch bolt and that is actuated to move relative to said latch bolt from a disengaging position to an engaging position, in which said second engaging member engages releasably said first engaging member, during movement of said latch bolt from said first retracted position to said extended position.

2. The door lock assembly of claim 1, wherein said latch bolt is hollow, defines an inner space, and has a shank portion and a tapered end portion tapered from said shank portion in a direction toward the socket, said shank portion being received in said hollow mounting body and to be disposed outwardly of the socket and said tapered end portion being capable of extending into the socket when said latch bolt is disposed at said first retracted position, said shank portion and said tapered end portion being capable of extending into the socket when said latch bolt is disposed at said extended position, said shank portion having two flat side walls that are parallel to each other, said tapered end portion having two side walls that are curvedly tapered from said side walls of said shank portion, each of said side walls of said shank portion being formed with a ball-mounting hole, said first engaging member having a pair of opposing engaging grooves that are adapted to be formed in the socket, said second engaging member including a pair of engaging balls that are disposed in said inner space in said latch bolt, that are respectively retained in said ball-mounting holes in said side walls of said shank portion, that protrude outwardly of and respectively through said ball-mounting holes, and that are operable to move relative to said latch bolt respectively toward and away from said engaging grooves in the socket such that said engaging balls engage respectively said engaging grooves in the socket when said second engaging member is disposed at said engaging position and that said engaging balls disengage respectively said engaging grooves in the socket when said second engaging member is disposed at said disengaging position.

3. The door lock assembly of claim 2, wherein said latch mechanism further includes a key-operated driving unit mounted in said hollow mounting body and operable to rotate about an axis transverse to said longitudinal direction, and a linking unit mounted movably in said hollow mounting body and disposed between and connected to said key-operated driving unit and said latch bolt so as to permit movement of said latch bolt between said first retracted position and said extended position upon actuation of said key-operated driving unit, said latch bolt being further operable so as to move from said first retracted position to a second retracted position, in which said tapered end portion is to be disposed outwardly of the socket and is received in said hollow mounting body when an external force is applied in said longitudinal direction to said tapered end portion of said latch bolt.

4. The door lock assembly of claim 3, wherein said hollow mounting body has two opposing first walls, each of which is formed with a pair of parallel guiding grooves extending in said longitudinal direction, and a flat surface between said guiding grooves, each of said side walls of said shank portion of said latch bolt being formed with a pair of guiding studs that extend respectively into said guiding grooves in a respective one of said first walls of said hollow mounting body, each of said balls being in sliding contact with said flat surface of a respective one of said first walls of said hollow mounting body when said shank portion of said latch bolt is retracted into said hollow mounting body.

5. The door lock assembly of claim 3, wherein said hollow mounting body defines a first space that receives said latch bolt therein when said latch bolt is disposed at said second retracted position, and a second space that accommodates said driving unit and said linking unit, said hollow mounting body being formed with a stopper protruding into said second space, a pair of opposing first retaining recesses that are opposite to each other in a transverse direction relative to said longitudinal direction, and a pair of opposing second retaining recesses, said first and second retaining recesses being disposed outwardly of and adjacent to said second space, said driving unit including a positioning pin that has two opposite ends extending respectively into said first retaining recesses when said latch bolt is disposed at said extended position, and respectively into said second retaining recesses when said latch bolt is disposed at one of said first and second retracted positions, said linking unit including a pushing lever, a stopping linkage, a middle linkage disposed between and pivoted to said pushing lever and said stopping linkage, and a pair of cranks having first ends that are pivoted to said stopping linkage, and second ends that are pivoted to said positioning pin, said pushing lever and being operable to move relative to said latch bolt in said longitudinal direction so as to push said engaging balls to move in said transverse direction to engage respectively said engaging grooves in the socket upon movement of said latch bolt to said extended position, said stopping linkage being stopped by said stopper when pushed to move in said longitudinal direction toward said hollow mounting body by an external force applied to said side walls of said tapered end portion of said latch bolt, thereby preventing movement of said latch bolt from said extended position to said first retracted position, said cranks being driven by said key-operated driving unit through said positioning pin to move along a circumferential path about said axis and to drive said stopping linkage to move along a curved path, in which said stopping linkage passes over said stopper when said driving unit is rotated about said axis in a first rotation direction, thereby permitting movement of said latch bolt from said extended position to said first retracted position.

6. The door lock assembly of claim 5, wherein said hollow mounting body has two opposing second walls confining said second space, each of said second walls being formed with a retaining bore that is in spatial communication with said second space, and a sector-shaped recess that is in spatial communication with said retaining bore, said key-operated driving unit including a pair of mated swingable members that are rotatable between locking and unlocking positions, and an urging member disposed between and sleeved on said swingable members for restoring said swingable members to said locking position, said latch bolt being disposed at said extended position when said swingable members are disposed at said locking position, said latch bolt being disposed at said first retracted position when said swingable members are disposed at said unlocking position, each of said swingable members including a ring-shaped body that is retained in said retaining bore in a respective one of said second walls, a pin-supporting arm that extends from said ring-shaped body and that is formed with an elongated slot for extension of said positioning pin therethrough, and a stopping protrusion that protrudes from said pin-supporting arm into said sector-shaped recess in the respective one of said second walls so as to limit the rotational range of said swingable members to be within said first and unlocking positions, said elongated slot permitting movement of said positioning pin along the length thereof and to disengage from said first retaining recesses upon rotation of said swingable members from said locking position toward said unlocking position.

7. The door lock assembly of claim 1, further comprising a mounting mechanism that includes opposite front and rear mounting seats which are adapted to be installed in a lock-mounting hole in the door panel and which sandwich said latch mechanism therebetween.

8. The door lock assembly of claim 7, wherein said mounting mechanism further includes front and rear pads that are respectively attached to said front and rear mounting seats, each of said front and rear pads having an outer surface that is adapted to be substantially flush with a respective one of front and rear sides of the door panel.

9. The door lock assembly of claim 6, wherein said ring-shaped body of each of said swingable members defines a non-circular engaging hole, said door lock assembly further comprising a front actuating mechanism that includes a front rose adapted to be attached to a front side of the door panel, a tubular lock-mounting seat extending coaxially into said front rose and rotatable relative to said front rose, a key-operated lock mounted in said lock-mounting seat, a front latch-driving member with a front driving rod extending into said engaging hole in said ring-shaped body of a respective one of said swingable members for driving rotation of said swingable members, a cam coupled to said key-operated lock so as to rotate upon actuation of said key-operated lock, and a cam follower coupled slidably to said lock-mounting seat and coupled to said cam so as to be driven by said cam to slide relative to said lock-mounting seat in said transverse direction from a first axial position to a second axial position, in which said cam follower is coupled to said front latch-driving member, which results in coupling of said front latch-driving member to said lock-mounting seat so as to permit co-rotation of said lock-mounting seat and said front latch-driving member.

10. The door lock assembly of claim 9, wherein said cam follower defines a non-circular engaging hole, said front driving rod of said front latch-driving member having a circular rod portion that extends into said engaging hole in said cam follower, and a non-circular rod portion that extends from said circular rod portion in a direction away from said cam follower, said non-circular rod portion being disposed outwardly of said non-circular engaging hole when said cam follower is disposed at said first axial position, said non-circular rod portion extending into and engaging releasably said non-circular engaging hole when said cam follower is disposed at said second axial position.

11. The door lock assembly of claim 10, wherein said lock-mounting seat includes an inner sleeve that surrounds said cam follower and that is formed with an elongated opening, and an outer sleeve that surrounds said inner sleeve and said key-operated lock and that is formed with a first opening, said cam having a hollow cam body with an outer surface, and an engaging stud that is mounted movably in said cam body and that protrudes outwardly from said outer surface into said elongated opening to abut slidingly against said outer sleeve so as to be retained together with said key-operated lock in said lock-mounting seat, said engaging stud being operable to move away from said elongated opening, said front rose being formed with a second opening that is registered with said first opening, said engaging stud being offset from said first and second openings when said cam is disposed at a locking position, said engaging stud being registered with said first and second openings when said cam is disposed at a predetermined angular position relative to said locking position, thereby permitting access to and operation of said engaging stud to move away from said elongated opening in said inner sleeve and thus permitting removal of said key-operated lock from said lock-mounting seat.

12. The door lock assembly of claim 11, wherein said engaging stud is spring-biased.

13. The door lock assembly of claim 11, wherein said engaging stud engages threadedly said cam body so as to be adjustable to move toward and away from said elongated opening in said inner sleeve.

14. The door lock assembly of claim 11, wherein said cam body defines an axial hole and a radial hole that is in spatial communication with said axial hole, said engaging stud extending into said radial hole and being formed with an engaging recess that is registered with said axial hole, said cam follower having an engaging rod that extends into said axial hole to engage releasably said engaging recess in said engaging stud.

15. The door lock assembly of claim 11, wherein said inner sleeve has an inserting end and an inner wall that is formed with an L-shaped recess which has an axial section extending axially from said inserting end, and a circumferential section extending circumferentially from said axial section, said inner wall being formed with an inner rib that defines said L-shaped recess, said key-operated lock being formed with two axially aligned outer ribs that cooperatively define a gap therebetween, said axial section of said L-shaped recess permitting extension of said outer ribs therethrough so as to permit extension of said key-operated lock into said inner sleeve and so as to permit said inner rib to extend through said gap between said outer ribs when said inner sleeve is rotated to a predetermined angle, thereby preventing axial movement of said key-operated lock relative to said inner sleeve.

16. The door lock assembly of claim 11, further comprising amounting mechanism that includes opposite front and rear mounting seats which are adapted to be installed in a lock-mounting hole in the door panel and which sandwich said latch mechanism therebetween, said front mounting seat being formed with a central hole, said swingable members being driven by said front latch-driving member to rotate from said locking position to said unlocking position when said front driving rod is rotated from a first angular position to a second angular position, said front driving rod extending through said central hole in said front mounting seat, said front latch-driving member further including an urging element that is sleeved on said non-circular rod portion of said front driving rod for restoring said front driving rod to said first angular position.

17. The door lock assembly of claim 16, wherein said front rose includes a ring-shaped base that is adapted to be attached to the front side of the door panel and that is secured to said front mounting seat, said lock-mounting seat being formed with a front handle, said front driving rod being driven by said lock-mounting seat to rotate from said first angular position to said second angular position when said front handle of said lock-mounting seat is rotated from a horizontal position to a vertical position, said lock-mounting seat further including an urging component that is sleeved on said outer sleeve for restoring said front handle of said lock-mounting seat to said horizontal position.

18. The door lock assembly of claim 17, wherein said front actuating mechanism further includes a plurality of screws that extend through said front mounting seat to engage threadedly said ring-shaped base of said front rose.

19. The door lock assembly of claim 9, wherein said cam follower is formed with an engaging hole, said front actuating mechanism further including a coupler that is sleeved on said front latch-driving member so as to be co-rotatable therewith and that is formed with a slide hole registered with said engaging hole in said cam follower, and a driving rod that is movably received in said slide hole, said door lock assembly further comprising a control unit that includes a control panel, and an electromagnetic valve with a pushing member which is controlled by said control panel to move toward and away from said driving rod, said driving rod being driven by said pushing member to move from a first radial position, in which said driving rod is disposed outwardly of said engaging hole in said cam follower, to a second radial position, in which said driving rod extends into said engaging hole in said cam follower so as to couple said cam follower to said front latch-driving member.

20. The door lock assembly of claim 19, wherein said front actuating mechanism further includes a retaining member that has a curved wall surrounding said coupler in such a manner so as to permit sliding abutment of said driving rod against said curved wall when said driving rod is rotated together with said coupler.

21. The door lock assembly of claim 1, further comprising a mounting mechanism that includes a front mounting seat which is adapted to be installed in a lock-mounting hole in the door panel, and a front actuating mechanism that includes a front rose adapted to be attached to a front side of the door panel and having a ring-shaped base which defines a central opening, and a tubular lock-mounting seat extending into said front rose, said ring-shaped base being disposed between said front mounting seat and said lock-mounting seat and being formed with a pair of diametrically positioning studs, each of which projects into said central opening and each of which is formed with a through-hole, said lock-mounting seat being formed with a pair of diametrically disposed screw holes, a pair of diametrically disposed axial slots, and a pair of circumferential slots that extend respectively and circumferentially from said axial slots and that are axially and respectively aligned with said screw holes, said axial slots permitting extension of said positioning studs therethrough and respectively into said circumferential slots upon rotation of said lock-mounting seat to a predetermined angle so as to permit coupling of said ring-shaped base to said lock-mounting seat and so as to permit alignment of said screw holes in said lock-mounting seat with said through-holes in said positioning studs, respectively, said front actuating mechanism further including a pair of screws that extend through said front mounting seat and said through-holes in said positioning studs to engage threadedly said screw holes in said lock-mounting seat.

22. The door lock assembly of claim 9, wherein said ring-shaped body of each of said swingable members defines a non-circular engaging hole, said door lock assembly further comprising a rear actuating mechanism that includes a rear rose adapted to be attached to a rear side of the door panel, a tubular handle seat extending into said rear rose, a pushing rod extending through and coupled releasably to said handle seat, and movable axially relative to said handle seat between a holding position and a releasing position, a positioning member mounted in said rear rose for positioning said pushing rod at a selected one of said holding and releasing positions, and a rear latch-driving member coupled to said pushing rod and extending into said engaging hole in said ring-shaped body of a respective one of said swingable members.

23. The door lock assembly of claim 22, wherein said rear actuating mechanism further includes a rear handle that is connected detachably to said handle seat.

24. The door lock assembly of claim 22, wherein said pushing rod is formed with a plurality of retaining grooves, said positioning member including a spring-biased positioning block that extends movably into a selected one of said retaining grooves.

25. The door lock assembly of claim 22, wherein said pushing rod has an engaging end that is disposed adjacent to a respective one of said swingable members, and that is formed with a plurality of engaging notches, said stopping protrusion of one of said swingable members, which is disposed adjacent to said engaging end of said pushing rod, extending into one of said engaging notches in said engaging end of said pushing rod when said pushing rod is disposed at said holding position.

26. The door lock assembly of claim 25, wherein one of said second walls of said hollow mounting body, which is disposed adjacent to said engaging end of said pushing rod, is formed with a non-circular recess that surrounds said retaining bore, said engaging end of said pushing rod being non-circular and being received in said non-circular recess in the respective one of said second walls when said pushing rod is disposed at said holding position.

27. The door lock assembly of claim 26, further comprising a mounting mechanism that includes a rear mounting seat which is adapted to be installed in a lock-mounting hole in the door panel, which is disposed between said rear rose and said hollow mounting body, and which is formed with a rod-engaging groove, said pushing rod being formed with an engaging protrusion that protrudes outwardly therefrom, that is disposed outwardly of said rod-engaging groove when said pushing rod is disposed at said releasing position, and that extends into said rod-engaging groove when said pushing rod is disposed at said holding position.

28. The door lock assembly of claim 22, wherein said rear actuating mechanism further includes a locking button mounted coaxially and rotatably on said handle seat, said pushing rod extending coaxially through said locking button and being formed with an axially extending groove that extends along the length of said pushing rod and that is defined by a groove-defining wall which is formed with at least a retaining indentation, said locking button defining a central hole, and having at least a locking protrusion that protrudes into said central hole and said axially extending groove in said pushing rod, said locking protrusion being axially offset from said retaining indentation when said pushing rod is disposed at said releasing position, and being radially aligned with said retaining indentation when said pushing rod is disposed at said holding position, said locking button being rotatable relative to said pushing rod from a non-retaining position to a retaining position, in which said locking protrusion is received in said retaining indentation, when said pushing rod is disposed at said holding position, thereby preventing axial movement of said pushing rod from said holding position to said releasing position.

29. The door lock assembly of claim 22, wherein said front rose is formed with a pair of threaded posts extending into the door panel, said rear actuating mechanism further including a pair of screw rods that extend through said handle seat and said latch mechanism and that engage threadedly and respectively said threaded posts of said front rose.

30. The door lock assembly of claim 29, wherein said rear actuating mechanism further includes a biasing member that is sleeved on said handle seat for urging said rear rose to abut against the rear side of the door panel.

31. The door lock assembly of claim 22, further comprising a mounting mechanism that includes front and rear mounting seats sandwiching said latch mechanism there between and disposed between said front and rear actuating mechanisms, said rear rose having at least a radially extending rear leg that is disposed adjacent to said rear mounting seat, and at least a rear threaded element that is secured to said radially extending rear leg, said rear actuating mechanism further including at least a rear adjusting screw that extends through and that abuts against said rear mounting seat and that engages threadedly said rear threaded element so as to permit adjustment of a distance between said rear mounting seat and said rear rose.

32. The door lock assembly of claim 31, wherein said front rose has at least a radially extending front leg that is disposed adjacent to said front mounting seat, and at least a front threaded element that is secured to said radially extending front leg, said front actuating mechanism further including at least a front adjusting screw that extends through and that abuts against said front mounting seat and that engages threadedly said front threaded element so as to permit adjustment of a distance between said front mounting seat and said front rose.
